(19) United States
(12) Patent Application Publication
(10) Pub. No.: US 2026/0337990 A1
(43) Pub. Date: Oct. 29, 2026

(54) Partition System

(71) Applicant: The Mills Partition Company, LLC, Marion, WI (US)

(72) Inventors: Ryan Rice, Menomonee Falls, WI (US); Matt Pounds, Menomonee Falls, WI (US); Tom Persick, Menomonee Falls, WI (US); Rahul Janardan Dadgale, Pune (IN)

(21) Appl. No.: 19/103,960

(22) PCT Filed: Aug. 14, 2023
(86) PCT No.: PCT/US2023/030163

§ 371 Date: Feb. 14, 2025

(30) Foreign Application Priority Data
Aug. 15, 2022 (IN) 202241046309

(51) Int. Cl. E04H 1/12; E05B 65/00; E05D 7/081

(52) U.S. Cl. CPC E04H 1/1266; E05B 65/0035; E05D 7/081; E05Y 2900/112

(57) ABSTRACT

A partition system includes a pilaster and a door repositionable relative to the pilaster between an open position and a closed position. The door includes a first panel including a first body and a strip formed as a first continuous piece. The first body defines at least one of a front face or a rear face of the door. The door further includes a second panel coupled to the first panel. The second panel includes a second body and a flange formed as a second continuous piece. A gap extends between the door and the pilaster when the door is in the closed position. The strip extends across the gap when the door is in the closed position.

### CROSS-REFERENCE TO RELATED PATENT APPLICATION

This application claims the benefit of and priority to Indian Provisional Application No. 202241046309, filed on Aug. 15, 2022, the entire disclosure of which is hereby incorporated by reference herein.

### TECHNICAL FIELD

The present disclosure relates generally to the field of partitions used in, for example, restrooms, to provide privacy for persons using the restroom. More specifically, the present disclosure relates to a “no-sight” partition system that inhibits or prevents a line of sight from being established from one side of a partition to another side of a partition.

### BACKGROUND

Various types of establishments, such as office buildings, educational facilities, recreational facilities, shopping areas, etc. typically provide areas such as restrooms, showers, changing rooms, or any of a wide variety of other types of facilities where users normally desire some level of privacy. In order to provide such privacy, partitions or partition systems may be used to provide areas or stalls (e.g., a bathroom stall, a shower stall, etc., a changing room, etc.) for private, individual use. A partition system typically includes one or more walls/panels, doors, and pilasters. The partition system may include generally flat panels that are fastened in a suitable fashion and provided with locks to facilitate people entering/exiting the stalls and obscuring a view of an outside observer into a particular stall when the stall is in use.

### SUMMARY

At least one embodiment relates to a partition system including a pilaster and a door repositionable relative to the pilaster between an open position and a closed position. The door includes a first panel including a first body and a strip formed as a first continuous piece. The first body defines at least one of a front face or a rear face of the door. The door further includes a second panel coupled to the first panel. The second panel includes a second body and a flange formed as a second continuous piece. A gap extends between the door and the pilaster when the door is in the closed position. The strip extends across the gap when the door is in the closed position.

Another embodiment relates to an assembly for a partition system. The assembly includes a first panel and a second panel. The first panel includes a first body and a first flange formed as a first continuous piece. The first body defines a first face of the assembly. The first flange extends substantially perpendicular to the first face. The second panel includes a second body and a second flange formed as a second continuous piece. The second body defines a second face of the assembly. The second flange extends substantially perpendicular to the second face. The first flange includes a connecting portion and an offset portion that is offset from the connecting portion. The connecting portion extends between the first body and the offset portion. The offset portion engages the second flange to couple the first panel to the second panel.

Another embodiment relates to a partition system defining a stall. The partition system includes a first pilaster, a second pilaster, and a door positioned to form a first gap between the door and the first pilaster and a second gap between the door and the second pilaster. The door includes a first panel and a second panel. The first panel defines an interior face of the door that faces toward the stall. The first panel includes a first vertical strip extending across the first gap. The second panel defines an exterior face of the door that faces away from the stall. The second panel includes a second vertical strip extending across the second gap and a flange coupling the second panel to the first panel.

Another embodiment relates to a partition system including a first pilaster, a second pilaster spaced from the first pilaster, and a door selectively repositionable between an open position and a closed position. The door includes a first panel including a first body coupled to a first inner flange, a second panel including a second body coupled to a first outer flange, and a strip. The strip includes (a) a mounting portion that extends between the first inner flange and the first outer flange to couple the strip to the first panel and the second panel and (b) an obscuring portion coupled to the mounting portion. A gap extends between the outer flange and the second pilaster when the door is in the closed position, and the obscuring portion of the strip extends across the gap when the door is in the closed position.

Another embodiment relates to a partition system including a first pilaster, a second pilaster spaced from the first pilaster, and a door selectively repositionable between an open position and a closed position. The door includes (a) a first panel including a first flat panel coupled to a side flange, the first flat panel and the side flange forming a first continuous piece, and (b) a second panel including a second flat panel coupled to a strip, the strip and the second flat panel forming a second continuous piece. A gap extends between the side flange and the second pilaster when the door is in the closed position, and the strip extends across the gap when the door is in the closed position.

Another embodiment relates to a partition system including a first pilaster, a second pilaster spaced from the first pilaster, and a door pivotally coupled to the first pilaster and selectively repositionable between an open position and a closed position. The door includes a main body defining a front face and a rear face of the door, a first door lip extending outward from the main body such that a first recess is defined between the first door lip and the main body, the first recess extending from the front face toward the rear face, and a second door lip extending outward from the main body such that a second recess is defined between the second door lip and the main body, the second recess extending from the front face toward the rear face. The first door lip extends toward the first pilaster and the second door lip extends toward the second pilaster when the door is in the closed position.

This summary is illustrative only and should not be regarded as limiting. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements.

FIG. 1 is a perspective view of a partition system, according to an exemplary embodiment.

FIG. 2 is a top view of the partition system of FIG. 1.

FIG. 3 is a perspective view of a door assembly of a partition system, according to an exemplary embodiment.

FIG. 4 is a top view of a pilaster of the door assembly of FIG. 3.

FIGS. 5 and 6 are perspective views of the door assembly of FIG. 3.

FIG. 7 is a top view of the door assembly of FIG. 3.

FIG. 8 is a front view of a door assembly of a partition system, according to another exemplary embodiment.

FIGS. 9 and 10 are perspective views of a door of the door assembly of FIG. 3.

FIGS. 11 and 12 are perspective views of a first panel of the door of FIG. 9.

FIGS. 13 and 14 are perspective views of a second panel of the door of FIG. 9.

FIG. 15 is a top section view of the door assembly of FIG. 3.

FIG. 16 is a side section view of the door assembly of FIG. 3.

FIG. 17 is a front view of a door assembly of a partition system, according to another exemplary embodiment.

FIGS. 18-21 are side section views of a door of a partition system, according to various exemplary embodiments.

FIGS. 22-35 are top section views of a door of a partition system, according to various exemplary embodiments.

FIGS. 36 and 37 are perspective views of a panel for a door, according to an exemplary embodiment.

FIG. 38 is a top view of a door assembly of a partition system, according to an exemplary embodiment.

FIGS. 39 and 40 are top detail views of the door assembly of FIG. 38.

FIGS. 41 and 42 are perspective views of the door assembly of FIG. 38.

FIGS. 43 and 44 are perspective views of a door of the door assembly of FIG. 40.

FIGS. 45 and 46 are perspective views of a first panel of the door of FIG. 43.

FIGS. 47 and 48 are perspective views of a second panel of the door of FIG. 43.

FIG. 49 is a bottom view of a strip of the door of FIG. 43.

FIG. 50 is a perspective view of the strip of FIG. 49.

FIGS. 51-54 are perspective views of the door of FIG. 43 at various stages of assembly.

FIG. 55 is a bottom section view of the door of FIG. 43.

FIG. 56 is a side section view of the door of FIG. 43.

FIG. 57 is a top section view of a pilaster of the door assembly of FIG. 38.

FIG. 58 is a top view of a door assembly of a partition system, according to another exemplary embodiment.

FIGS. 59 and 60 are top detail views of the door assembly of FIG. 58.

FIGS. 61 and 62 are perspective views of the door assembly of FIG. 58.

FIGS. 63 and 64 are perspective views of a door of the door assembly of FIG. 60.

FIGS. 65 and 66 are perspective views of a first panel of the door of FIG. 63.

FIGS. 67 and 68 are perspective views of a second panel of the door of FIG. 63.

FIG. 69 is a bottom section view of the door of FIG. 63.

FIG. 70 is a top view of a door assembly of a partition system, according to an exemplary embodiment.

FIGS. 71 and 72 are top detail views of the door assembly of FIG. 70.

FIGS. 73 and 74 are perspective views of the door assembly of FIG. 70.

FIGS. 75 and 76 are perspective views of a door of the door assembly of FIG. 70.

FIGS. 77 and 78 are perspective views of a first panel of the door of FIG. 76.

FIGS. 79 and 80 are perspective views of a second panel of the door of FIG. 76.

FIG. 81 is a bottom section view of the door of FIG. 76.

FIG. 82 is a side section view of the door of FIG. 76.

FIG. 83 is a top view of a door assembly of a partition system, according to another exemplary embodiment.

FIG. 84 is a perspective view of a pilaster of the door assembly of FIG. 83.

FIG. 85 is a top detail view of the pilaster of FIG. 84.

FIG. 86 is a perspective view of a sidewall of a partition system.

FIG. 87 is a top section view of the sidewall of FIG. 86.

FIG. 88 is a right section view of the sidewall of FIG. 86.

FIGS. 89 and 90 are perspective views of a door of a partition system, according to another exemplary embodiment.

FIG. 91 is a front view of the door of FIG. 89.

FIG. 92 is a rear view of the door of FIG. 89.

FIG. 93 is a front view of the door of FIG. 89 including a series of filler strips, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As used herein, the term “continuous piece” means a component or member including one or more sections or portions that are integrally formed with one another without an intermediate coupling member (e.g., a fastener, a bracket, an adhesive, etc.). By way of non-limiting example, the continuous piece may be formed by bending, welding, extruding, drawing, casting, molding, or other operations.

Referring generally to the Figures, various embodiments disclosed herein relate to no-sight partition systems arranged to block or substantially block lines of sight into a stall. Specifically, the no-sight partition system includes doors and pilasters that are arranged to partially or completely block lines of sight between a door and a pilaster (e.g., into a stall). This is beneficial to provide an enhanced level of privacy to the person in the stall, which may provide that person with a sense of comfort. In one embodiment, a door includes a first panel including a first strip and a second panel including a second strip. When the door is closed, the first strip extends across a lock-side gap between the door and a first pilaster, blocking a line of sight between the door and the first pilaster. Additionally, when the door is closed, the second strip extends across a hinge-side gap between the door and a second pilaster, blocking a line of sight between the door and the second pilaster. The first panel further includes a main body and a flange extending away from the main body. The flange engages the second panel to couple the first panel to the second panel. The main body, the flange, and the first strip are formed from a single, continuous piece of material.

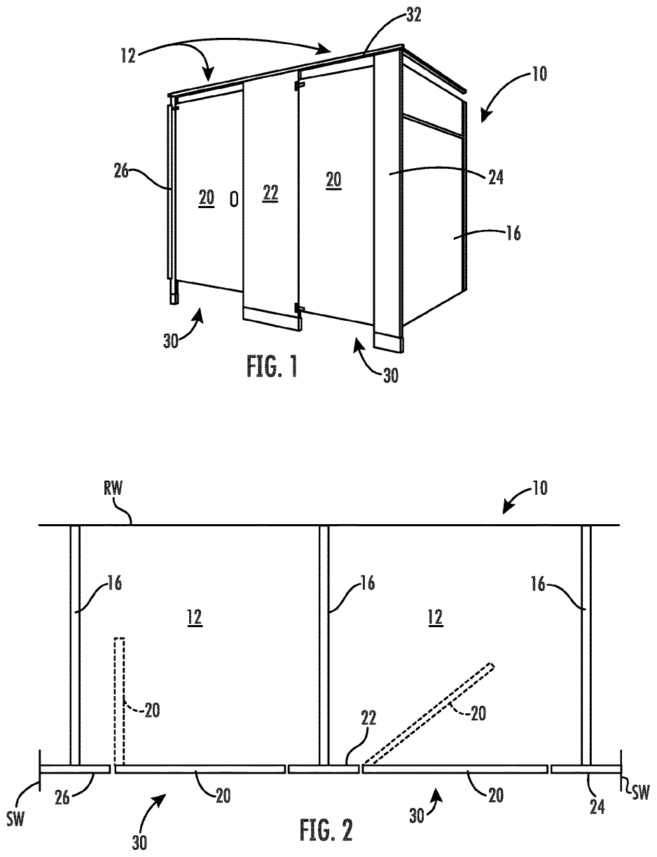

Referring to FIGS. 1 and 2, according to an exemplary embodiment, a no-sight partition assembly or no-sight partition system, shown as partition system 10, is located within a facility (e.g., a restroom, shower, changing room, etc.). The partition system 10 defines a pair of partitioned areas, shown as stalls 12 (e.g., a restroom stall, a changing or dressing room stall, a shower stall, etc.). The partition system 10 provides security and privacy to users of stall 12 such that others may not enter or see into the stall 12 when the stall 12 is in use. It should be understood that according to various embodiments, the stall 12 may be used in any of a variety of applications (e.g., restrooms, showers, dressing rooms, etc.), and the teachings herein extend to all such applications.

As shown, the partition system 10 defines two stalls positioned adjacent one another along a rear wall (RW) of the room. In other embodiments, the partition system 10 defines more or fewer stalls 12. The stalls 12 are separated from one another by partitions (e.g., partitions, faces, stiles, dividers, panels, wall members, etc.), shown as sidewalls 16 (also referred to as panels 16), that extend outward from the rear wall (RW). The sidewalls 16 may be coupled to the rear wall RW. In other embodiments, the rear wall (RW) may be replaced with one or more additional partitions or walls.

Along a front side of each stall 12, the partition system 10 includes a door subassembly (e.g., a partition, a face, a stile, a divider, a panel, a wall member, etc.), shown as door 20. Each door 20 is selectively repositionable or otherwise movable between a closed position (shown in solid lines in FIG. 2) and an open position (shown in dashed lines in FIG. 2). In the closed position, the door 20 obstructs and, in particular prevents, access to the stall 12 and obscures a view into the stall 12. In the open position, the door 20 permits access to the stall 12 and direct sight into the stall 12. The door 20 may open into the stall 12 (i.e., open inward) or open away from the stall 12 (i.e., open outward).

The doors 20 are each provided between pilasters (e.g., partitions, faces, stiles, dividers, panels, wall members, etc.), shown as pilaster 22, pilaster 24, and pilaster 26. One door 20 is pivotally and particularly, hingedly, coupled to the pilaster 22 and extends toward the pilaster 24. A lock assembly may selectively couple the door 20 to the pilaster 24 (e.g., to secure the door 20 when the stall 12 is occupied). The other door 20 is pivotally coupled to the pilaster 26 and extends toward the pilaster 22. A similar lock assembly may be provided for this stall 12. Each of the pilaster 22, the pilaster 24, and the pilaster 26 is coupled to a corresponding sidewall 16. Accordingly, each stall 12 is formed between the rear wall (RW), a pair of adjacent sidewalls 16, a pair of adjacent pilasters (e.g., the pilaster 22 and the pilaster 24 or the pilaster 22 and the pilaster 26), and a door 20. Together, each pair of adjacent pilasters and the corresponding door 20 form a partition assembly or partition system 30.

In some embodiments, one or more of the pilasters are otherwise supported. A bottom end of each of the pilaster 22, the pilaster 24, and the pilaster 26 may each be coupled to a support surface, such as a floor of the stall 12. As shown in FIG. 2, the pilaster 24 is coupled to a first side wall SW, and the pilaster 26 is coupled to a second side wall (SW). As shown in FIG. 1, the top ends of the pilaster 22, the pilaster 24, and the pilaster 26 are each coupled to a horizontal support, shown as rail 32. The rail 32 may be coupled to the rear wall (RW) and/or one or more of the side walls (SW).

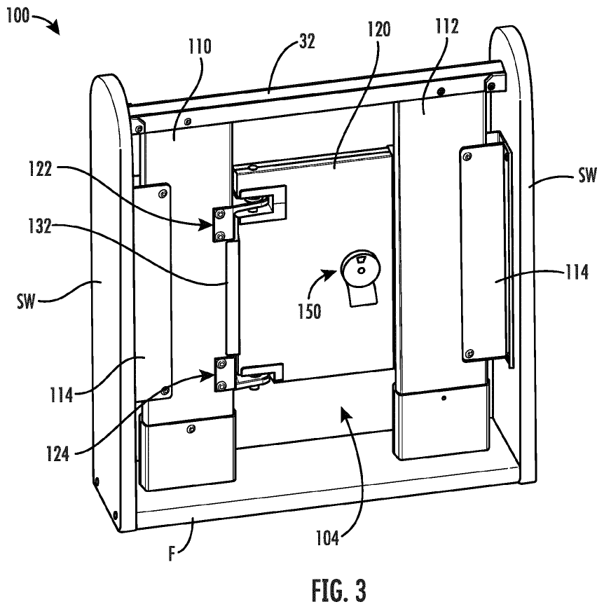

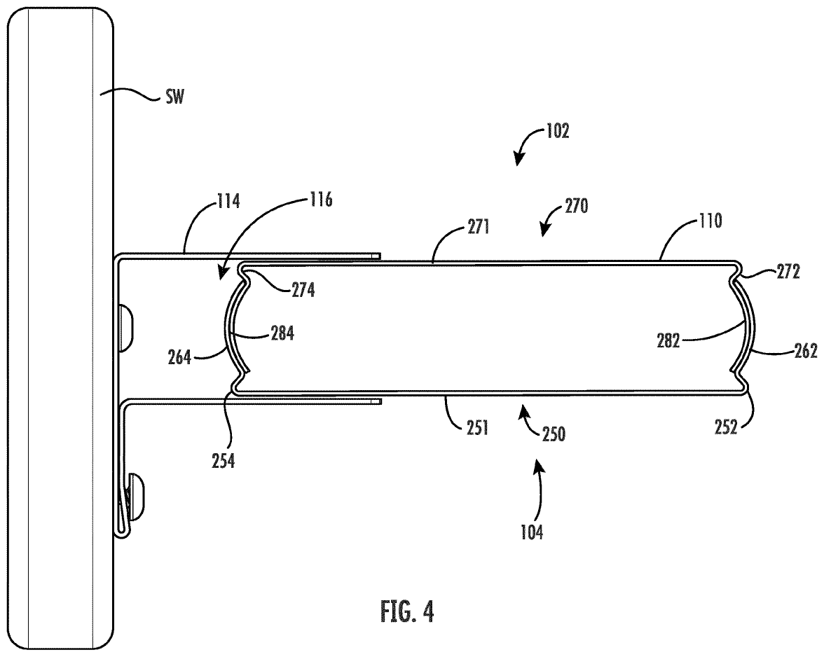

Referring to FIGS. 3 and 4, a partition system 100 is shown according to an exemplary embodiment. The partition system 100 is an example of the partition system 30. As shown, the partition system 100 includes a pair of side walls (SW) and a floor (F). A rail 32 extends laterally between the side walls (SW). Each end of the rail 32 is coupled to one of the side walls SW. The partition system 100 has an interior side 102 that faces inward toward the stall 12 and an exterior side 104 that faces outward, away from the stall 12.

The partition system 100 includes a pair of pilasters (e.g., faces, stiles, dividers, panels, wall members, etc.), shown as pilaster 110 and pilaster 112. The pilaster 110 and the pilaster 112 each have a lower end portion that is coupled to the floor F and an upper end portion that is coupled to the rail 32. The partition system 100 includes a pair of brackets or frame members, shown as pilaster brackets 114, each coupled (e.g., fastened) to one of the side walls SW. As shown in FIG. 4, each of the pilaster brackets 114 defines a groove, slot, channel, or recess, shown as pilaster channel 116, extending vertically along a length of the pilaster bracket 114. The pilaster channel 116 of a first pilaster bracket 114 receives the pilaster 110, such that the first pilaster bracket 114 couples the pilaster 110 to a first side wall (SW). The pilaster channel 116 of a second pilaster bracket 114 receives the pilaster 112, such that the second pilaster bracket 114 couples the pilaster 112 to a second side wall (SW).

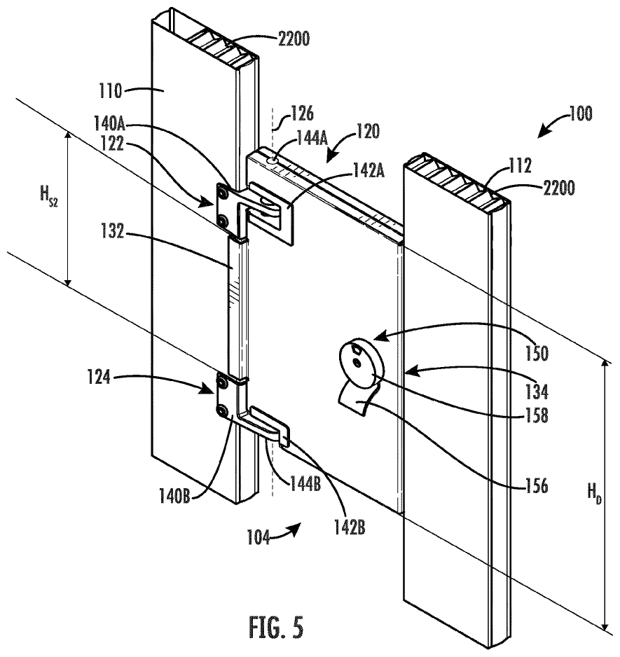

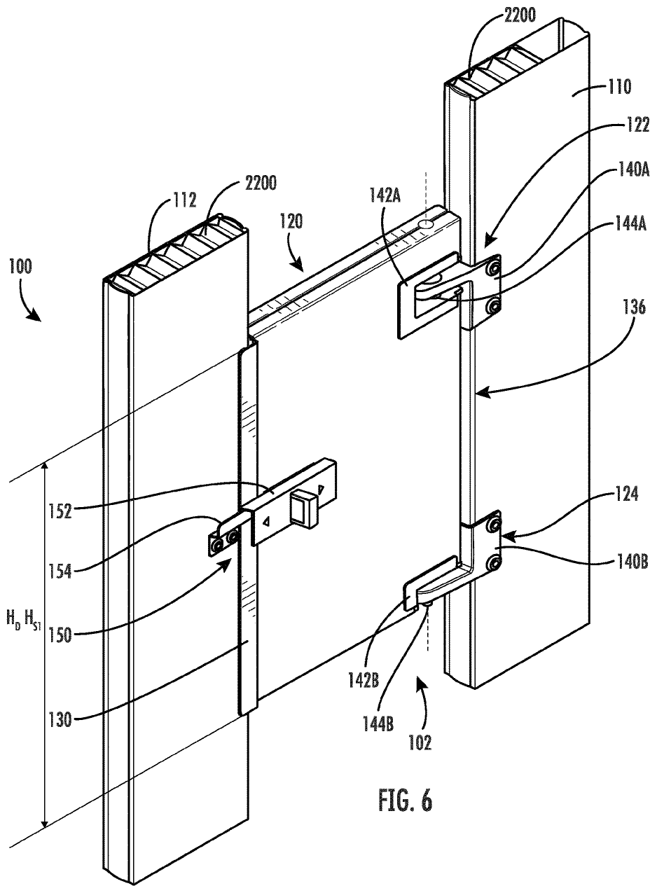

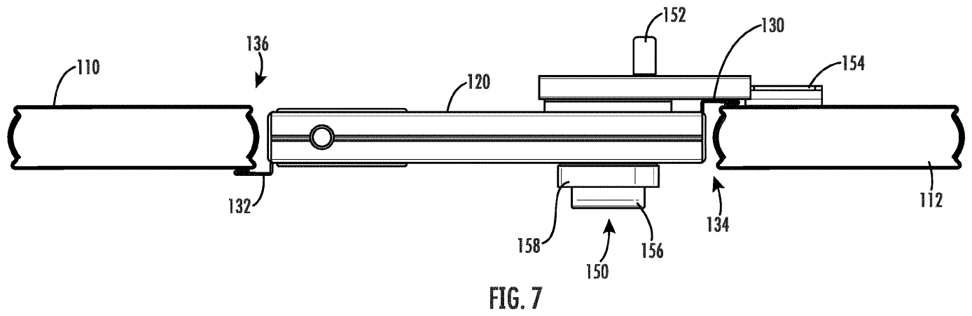

Referring to FIGS. 5-7, a door subassembly or panel, shown as door 120, is pivotally coupled to the pilaster 110 by a pair of hinge assemblies, shown as upper hinge 122 and lower hinge 124, such that the door 120 rotates about an axis 126 that extends substantially vertically through the center of the upper hinge 122 and the lower hinge 124. As shown, the door 120 opens inward, and the hinges 122 and 124 are positioned on the left side of the door 120 as viewed from outside of the stall. In other embodiments, the door 120 opens outwards, and/or the hinges 122 and 124 are positioned on the right side of the door 120 as viewed from outside of the stall.

The door 120 includes a pair of no-sight strips, flanges, extensions, members, elements, protrusions, sight blockers, sight obscurers, or privacy screens, shown as strip 130 and strip 132, positioned on opposite sides (e.g., left and right sides) of the door 120. Specifically, the strip 130 is positioned opposite the hinges 122 and 124, and the strip 132 is positioned on the same side of the door 120 as the hinges 122 and 124. The strip 130 and the strip 132 facilitate blocking lines of sight between the door 120 and the pilasters 110 and 112.

A first space or gap, shown as lock-side gap 134, extends and is defined between the door 120 and the pilaster 112 when the door 120 is in the closed position. Accordingly, the lock-side gap 134 extends along a side of the door 120 opposite the hinges 122 and 124 (i.e., closest to the lock assembly 150). A second space or gap, shown as hinge-side gap 136, extends and is defined between the door 120 and the pilaster 110 when the door 120 is in the closed position. Accordingly, the hinge-side gap 136 extends along a side of the door 120 closest to the hinges 122 and 124 (i.e., opposite the lock assembly 150). Conventionally, the hinge-side gap 136 and the lock-side gap 134 would be uncovered, permitting an observer located outside the stall to look therethrough, at a detriment to the privacy of a user located within the stall. Instead, the strip 132 extends across the hinge-side gap 136, and the strip 130 extends across the lock-side gap 134, preventing sight therethrough and improving the privacy of the user in the stall.

The upper hinge 122 includes a first body, bracket, or base, shown as hinge body 140A, pivotally coupled to a second body, bracket, or clevis, shown as hinge body 142A, by a rod or pin 144A. Similarly, the lower hinge 124 includes a first body, bracket, or base, shown as hinge body 140B, pivotally coupled to a second body or bracket, shown as hinge body 142B, by a rod or pin 144B. The hinge body 140A and the hinge body 140B are coupled (e.g., fastened) to the pilaster 110. The hinge body 142A and the hinge body 142B are coupled (e.g., fastened) to the door 120. The pin 144A extends through the hinge body 140A and the hinge body 142A to pivotally couple the hinge body 142A to the hinge body 140A. The pin 144B extends through the hinge body 140B and the hinge body 142B to pivotally couple the hinge body 142B to the hinge body 140B. The pin 144A and the pin 144B extend substantially vertically and are aligned with (e.g., centered about) the axis 126.

As shown, the hinge body 142A extends both above and below (e.g., surrounds or straddles) the hinge body 140A, whereas the hinge body 142B does not extend below the hinge body 140B. This arrangement may facilitate assembly of the partition system 100. By way of example, when installing the door 120, a user may set the hinge body 142B atop the hinge body 140B to support the weight of the door 120. The user may then rotate the door 120 to bring the hinge body 140A within the hinge body 142A without having to support the full weight of the door 120.

Referring to FIGS. 5 and 6, the partition system 100 further includes a lock assembly, latch assembly, indicator, indicator latch, or handle, shown as lock assembly 150, that selectively couples the door 120 to the pilaster 112 to selectively prevent movement of the door 120 out of the closed position. The lock assembly 150 includes a lock or latch, shown as sliding latch 152, that is slidably coupled to the door 120. The sliding latch 152 is selectively repositionable along a horizontal axis between a locked position and an unlocked position. In the locked position, the sliding latch 152 engages a fixed component, shown as lock tab 154, to limit (e.g., prevent) movement of the door 120. The lock tab 154 is coupled (e.g., fastened) to the pilaster 112. In the open position, the sliding latch 152 is disengaged from the lock tab 154 such that the door 120 is free to swing.

A manipulator, grip, or handle, shown as handle 156, is coupled to an exterior surface of the door 120. The handle 156 facilitates a user pulling the door 120 toward the closed position. A vacancy indicator or visual indicator, shown as indicator 158, is coupled to the door 120 and the sliding latch 152. The indicator 158 is configured to visually indicate a status of the sliding latch 152. By way of example, the indicator 158 may be coupled to the sliding latch 152 such that a movement of the sliding latch 152 causes a corresponding movement of the indicator to expose different parts of the indicator 158. When the sliding latch 152 is in the locked position, a first exposed portion of the indicator 158 may be shown, providing a first visual indication (e.g., showing the color red or the phrase “occupied”) to indicate to an observer that the stall is occupied. When the sliding latch 152 is in the unlocked position, a second exposed portion of the indicator 158 may be shown, providing a second visual indication (e.g., showing the color green or the phrase “vacant”) to indicate to an observer that the stall is vacant. In other embodiments, the partition system 100 includes a different type of lock assembly 150 (e.g., a rotating latch).

Referring to FIGS. 5 and 6, the door 120 has a height H_{D} measured vertically. The strip 130 has a height H_{S1} measured vertically. The strip 132 has a height H_{S2} measured vertically. As shown, the height H_{S1} of the strip 130 is approximately equal to the height H_{D} of the door 120. Accordingly, the strip 130 may cover substantially the entire height of the lock-side gap 134. In other embodiments, the height H_{S1} of the strip 130 is less than the height H_{D} of the door 120. The strip 132 extends between the upper hinge 122 and the lower hinge 124. Accordingly, the height H_{S2} may vary based on the positions of the hinges 122 and 124. In some embodiments, the height H_{S2} is less than the height H_{S1} of the strip 130 and the height H_{D} of the door 120. By way of example, the height H_{S2} of the strip 132 may be at least 0.5, 0.75, 0.8, 0.9, or 0.95 times the height H_{D} of the door 120.

Accordingly, the strip 132 may cover at least 50%, 75%, 80%, 90%, or 95% of the hinge-side gap 136. Covering large portions of the hinge-side gap 136 and the lock-side gap 134 is advantageous, as this minimizes the uncovered portions of the hinge-side gap 136 and the lock-side gap 134 that might otherwise permit a line of sight therethrough.

The dimensions of the partition system 100 shown in the various embodiments disclosed herein are exemplary only and are not intended to be limiting. In other embodiments, the partition system 100 is otherwise dimensioned. By way of example, the door 120 may have a different height and/or width depending upon the desired size of the stall.

In other embodiments, such as the embodiment shown in FIG. 8, the strip 132 has a gap that receives the hinge body 142A, such that the strip 132 extends both above and below the hinge body 142A. By way of example, the strip 132 may include an upper portion above the hinge body 142A and a lower portion below the hinge body 142A. In such an embodiment, the collective portions of the hinge-side gap 136 covered by the strip 132 should be considered when determining the percentage of the hinge-side gap 136 that is covered by the strip 132. By way of example, if the strip 132 included a first portion that extended along 20% of the height H_{D} of the door 120 and a second portion that extended along 60% of the height H_{D} of the door 120, the strip 132 would be considered to cover 80% of the hinge-side gap 136. Similarly, in other embodiments, the strip 130 may include multiple discrete portions arranged vertically to cover the lock-side gap 134. In such an embodiment, the collective portions of the lock-side gap 134 covered by the portions of strips 130 should be considered when determining the percentage of the lock-side gap 134 that is covered by the strip 130. By way of example, if the strip 130 included a first portion that extended along 30% of the height H_{D} of the door 120 and a second portion that extended along 30% of the height H_{D} of the door 120, the strip 130 would be considered to cover 60% of the lock-side gap 134.

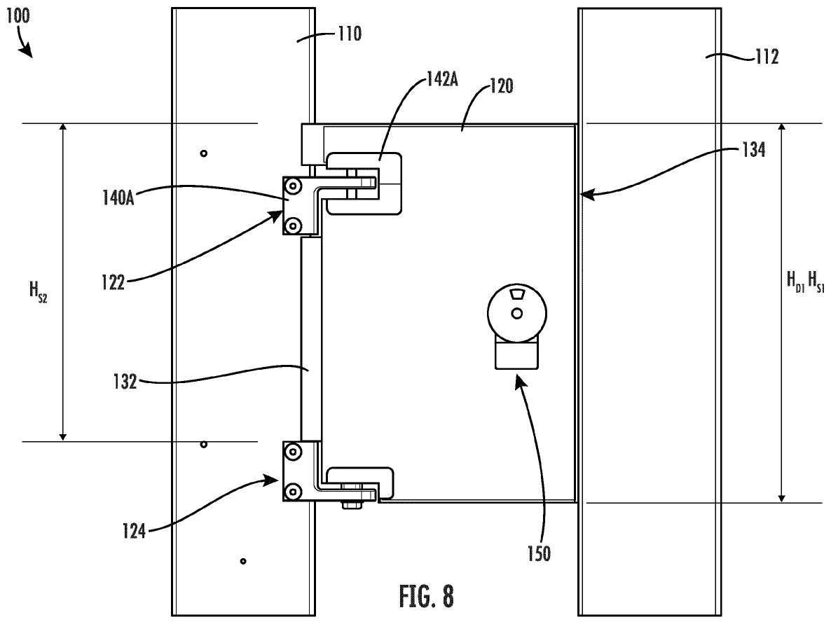

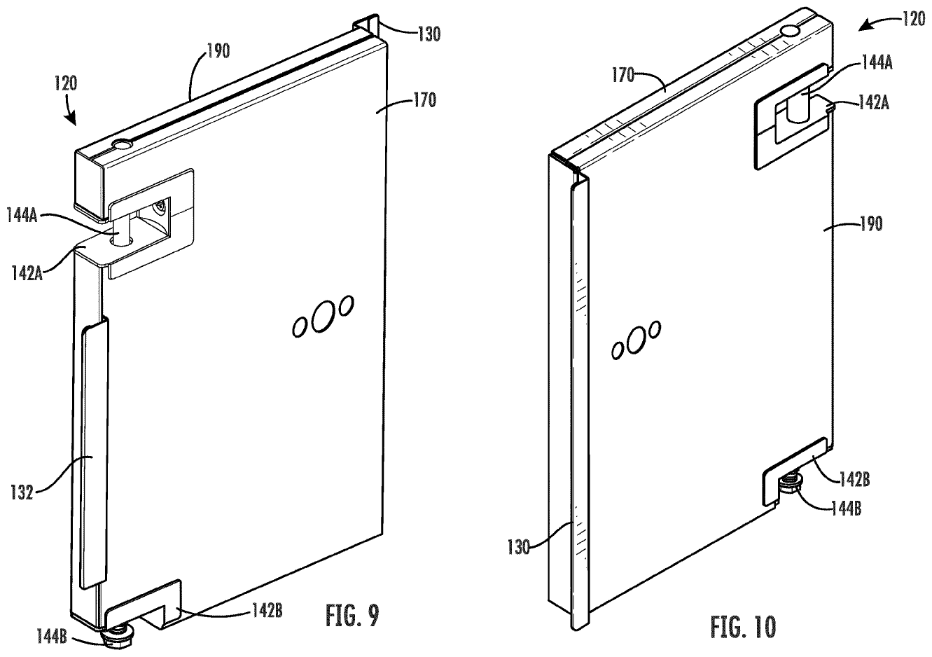

Referring to FIGS. 9-16, the door 120 is shown according to an exemplary embodiment. The door 120 includes a first panel or body, shown as panel 170, and a second panel or body, shown as panel 190. As shown, the panel 170 is an exterior panel (i.e., facing away from the stall), and the panel 190 is an interior panel (i.e., faces toward the stall). In other embodiments where the door 120 opens outward, the panel 170 is an interior panel, and the panel 190 is an exterior panel. The strip 130, the strip 132, the panel 170, and the panel 190 are fixedly coupled to one another to form the door 120. By way of example, the strip 130, the panel 170, and/or the panel 190 may be coupled to one another using welding (e.g., tack welding, spot welding, etc.), adhesive (e.g., epoxy, etc.), a press fit (e.g., having a wedge shaped component that is forced between two other components, etc.), interlocking components, fasteners, or other types of coupling. In some embodiments, the strip 130 and the panel 190 are integrally formed as a single, continuous piece. In some embodiments, the strip 132 and the panel 170 are integrally formed as a single, continuous piece.

Referring to FIGS. 11 and 12, the panel 170 is shown according to an exemplary embodiment. The panel 170 includes a flat, rectangular body or panel, shown as main body 171, defining a face (e.g., a front face or rear face) of the door 120. The main body 171 has a series of edges or contours, shown as bottom edge 172, side edge 174, top edge 176, and side edge 178. The bottom edge 172 is positioned opposite the top edge 176, and the side edge 174 is positioned opposite the side edge 178. As shown, each of the edges are substantially straight. A series of protrusions or flanges each extend away from the main body 171 and along a corresponding edge. Specifically, a bottom flange 182 extends along the bottom edge 172, a side flange 184 extends along the side edge 174, a top flange 186 extends along the top edge 176, and a side flange 188 extends along the side edge 178. The main body 171, the bottom flange 182, the side flange 184, the top flange 186, and the side flange 188 are formed as a single, continuous piece. By way of example, the bottom flange 182, the side flange 184, the top flange 186, the side flange 188, and the main body 171 may be formed from a single piece of bent sheet metal. Accordingly, the panel 170 may have a unitary construction. In other embodiments, the panel 170 is formed from multiple separate pieces coupled to one another.

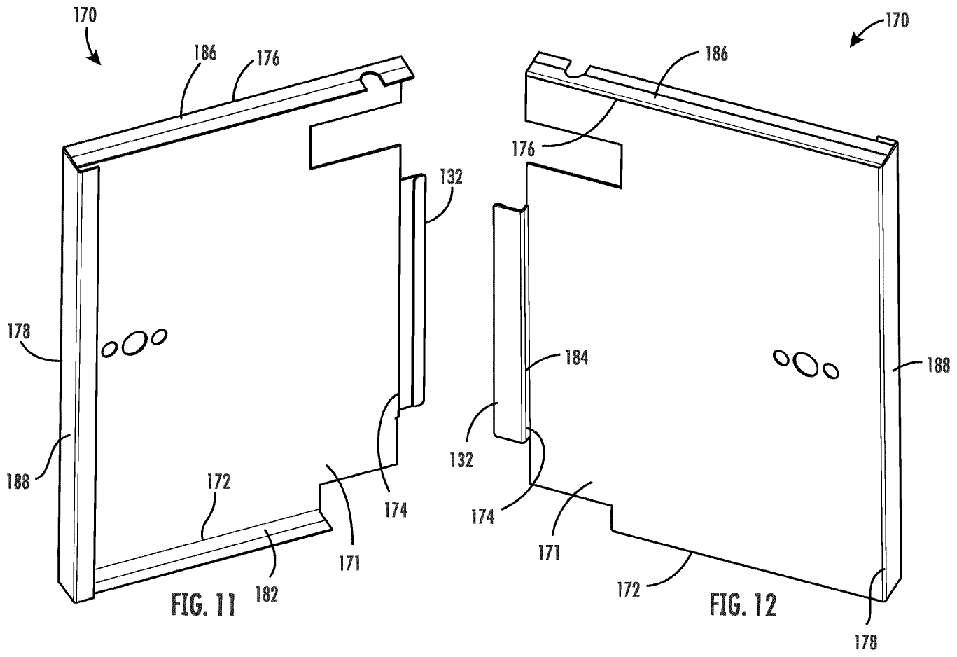

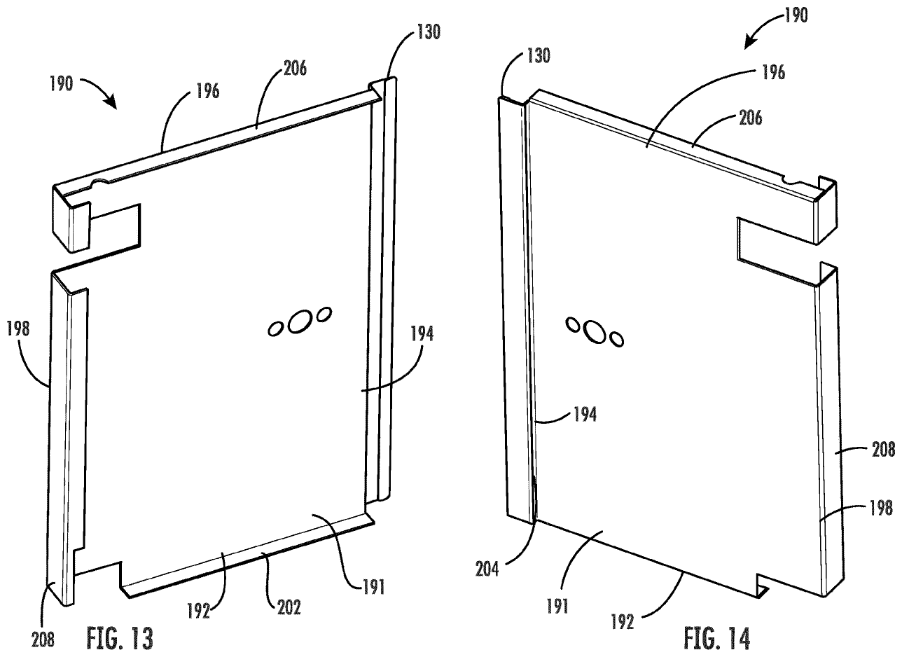

Referring to FIGS. 13 and 14, the panel 190 is shown according to an exemplary embodiment. The panel 190 includes a flat, rectangular body or panel, shown as main body 191, defining a face (e.g., a front face or rear face) of the door 120. The main body 191 has a series of edges or contours, shown as bottom edge 192, side edge 194, top edge 196, and side edge 198. The bottom edge 192 is positioned opposite the top edge 196, and the side edge 194 is positioned opposite the side edge 198. As shown, each of the edges are substantially straight. A series of protrusions or flanges each extend away from the main body 191 and along a corresponding edge. Specifically, a bottom flange 202 extends along the bottom edge 192, a side flange 204 extends along the side edge 194, a top flange 206 extends along the top edge 196, and a side flange 208 extends along the side edge 198. The main body 191, the bottom flange 202, the side flange 204, the top flange 206, and the side flange 208 are formed as a single, continuous piece. By way of example, the bottom flange 202, the side flange 204, the top flange 206, the side flange 208, and the main body 191 may be formed from a single piece of bent sheet metal. Accordingly, the panel 190 may have a unitary construction. In other embodiments, the panel 190 is formed from multiple separate pieces coupled to one another.

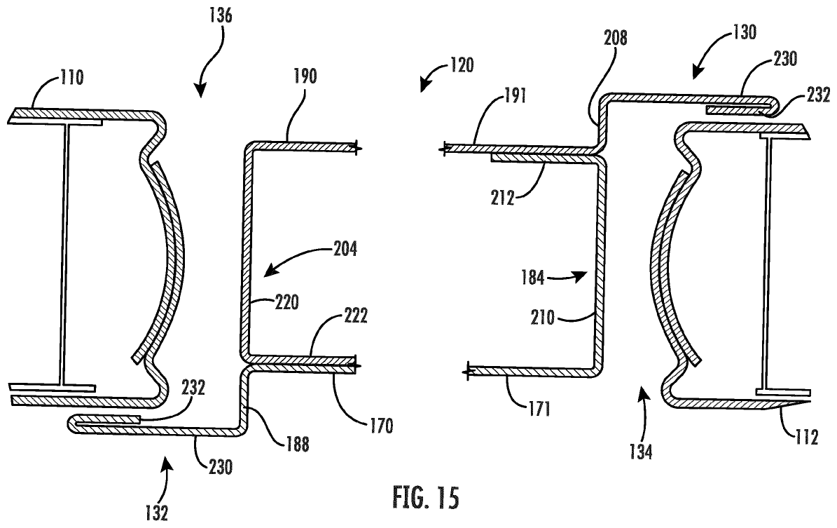

Referring to FIG. 15, the side flange 184 couples the panel 170 to the panel 190. The side flange 184 includes a first portion, shown as middle portion 210, and a second portion, shown as distal portion 212. The middle portion 210 extends inward from the main body 171 and substantially perpendicular to the main body 171. The middle portion 210 extends between the main body 171 and the distal portion 212, coupling the distal portion 212 to the main body 171. The distal portion 212 extends substantially perpendicular to the middle portion 210 and substantially parallel to the main body 171. The distal portion 212 is offset from the main body 171 and extends along an inner surface of the main body 191. As the distal portion 212 abuts the main body 191, the distal portion 212 and the main body 191 may be fixedly coupled to one another though welding (e.g., plug welding, laser welding, etc.), adhesive (e.g., epoxy, glue, etc.), fasteners (e.g., rivets, screws, etc.), or another type of coupling.

The side flange 204 couples the panel 190 to the panel 170. The side flange 204 includes a first portion, shown as middle portion 220, and a second portion, shown as distal portion 222. The middle portion 220 extends inward from the main body 191 and substantially perpendicular to the main body 191. The middle portion 220 extends between the main body 191 and the distal portion 222, coupling the distal portion 222 to the main body 191. The distal portion 222 extends substantially perpendicular to the middle portion 220 and substantially parallel to the main body 191. The distal portion 222 is offset from the main body 191 and extends along an inner surface of the main body 171. As the distal portion 222 abuts the main body 171, the distal portion 222 and the main body 171 may be fixedly coupled to one another though welding (e.g., plug welding, laser welding, etc.), adhesive (e.g., epoxy, glue, etc.), fasteners (e.g., rivets, screws, etc.), or another type of coupling.

The strip 130 and the strip 132 each include a primary portion, obscuring portion, or flange, shown as flat portion 230, and a secondary portion or flange, shown as folded portion 232. The flat portion 230 and the folded portion 232 are formed as a single, continuous piece (e.g., a bent piece of sheet metal). The folded portion 232 is folded over onto the flat portion 230 thereby increasing the strength of the strip 132 and reducing a presence of sharp or relatively sharp edges at a user interface (i.e., a location where a user may grab, hold, or otherwise engage with the object, such as the door, strip 132, etc.). The folded portion 232 and the flat portion 230 both extend substantially parallel to the main body 171 and the main body 191.

The side flange 188 extends outward from the main body 171 and substantially perpendicular to the main body 171. The side flange 188 couples the flat portion 230 of the strip 132 to the main body 171. Specifically, the side flange 188 and the flat portion 230 are integrally formed as a single, continuous piece. The side flange 188 offsets the strip 132 outward from the main body 171, permitting the strip 132 to extend across the hinge-side gap 136 and overlap the pilaster 110 when the door 120 is in the closed position. When the door 120 is opened, the strip 132 moves or swings away from the pilaster 110 (i.e., downward as shown in FIG. 15) to permit access to the stall.

The side flange 208 extends outward from the main body 191 and substantially perpendicular to the main body 191. The side flange 208 couples the flat portion 230 of the strip 130 to the main body 191. Specifically, the side flange 208 and the flat portion 230 are integrally formed as a single, continuous piece. The side flange 208 offsets the strip 130 outward from the main body 191, permitting the strip 132 to extend across the lock-side gap 134 and overlap the pilaster 112 when the door 120 is in the closed position. When the door 120 is opened, the strip 130 moves or swings away from the pilaster 112 (i.e., upward as shown in FIG. 15) to provide clearance and permit access to the stall.

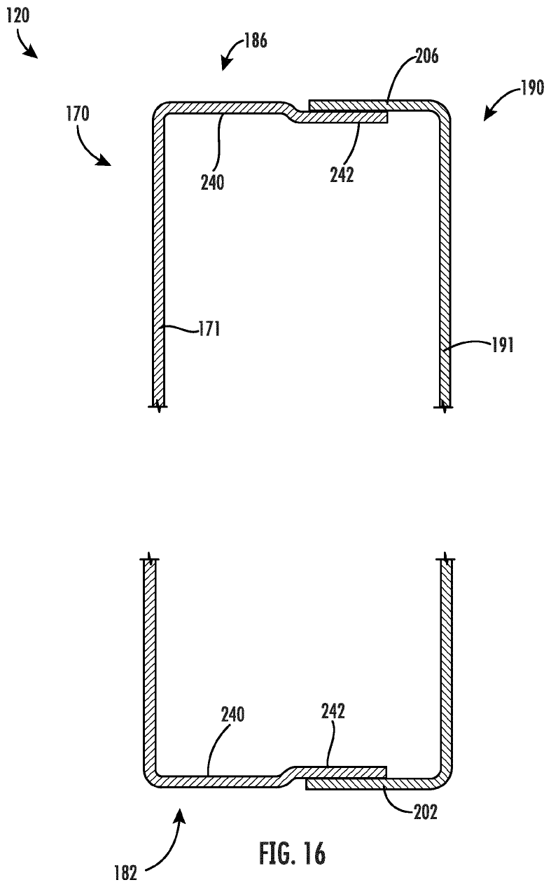

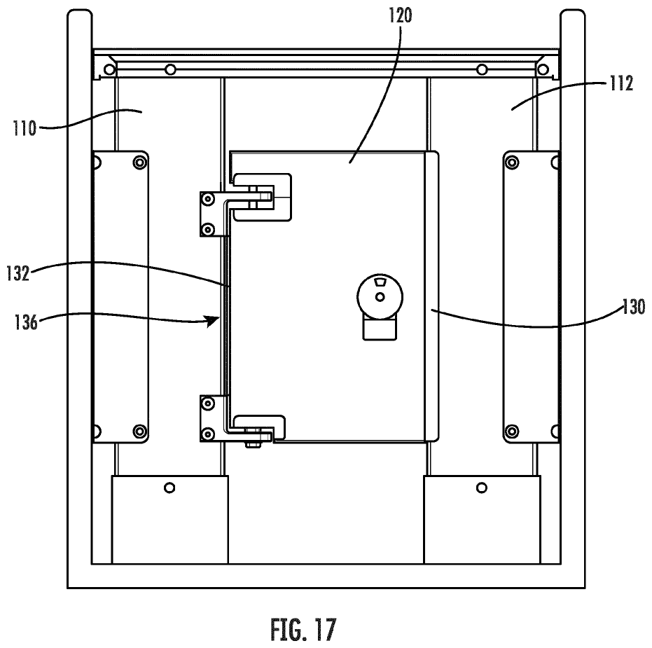

FIG. 17 illustrates the door 120 in the closed position. With reference to FIG. 15 in combination with FIG. 17, in the closed position, the lock-side gap 134 is defined between the pilaster 112 and the side flange 184. The side flange 208 and the strip 130 extend across the lock-side gap 134, blocking some or all potential lines of sight through the lock-side gap 134. In the closed position, the hinge-side gap 136 is defined between the pilaster 110 and the side flange 204. The side flange 188 and the strip 132 extend across the hinge-side gap 136, blocking some or all potential lines of sight through the hinge-side gap 136. Accordingly, the door 120 beneficially provides a no-sight system that ensures the privacy of an occupant of the stall 12.

Referring to FIG. 16, the top flange 186 and the bottom flange 182 each include an outer portion or connecting portion, shown as exposed portion 240, and an inner portion, offset portion, covered portion, or jogged portion, shown as inset portion 242. The exposed portion 240 and the inset portion 242 are formed as a single, continuous piece (e.g., a bent piece of sheet metal). The exposed portion 240 and the inset portion 242 are both substantially perpendicular to the main body 171. The exposed portion 240 extends between the main body 171 and the inset portion 242, coupling the inset portion 242 to the main body 171. The inset portion 242 is offset inward from the exposed portion 240 by the thickness of the material used to form the panel 190. When assembled, the inset portion 242 of the top flange 186 extends along an inner surface of the top flange 206. Similarly, the inset portion 242 of the bottom flange 182 extends along an inner surface of the bottom flange 202. As the inset portions 242 abut the top flange 206 and the bottom flange 202, the inset portions 242 may be fixedly coupled to the top flange 206 and the bottom flange 202 though welding (e.g., plug welding, laser welding, etc.), adhesive (e.g., epoxy, glue, etc.), fasteners (e.g., rivets, screws, etc.), or another type of coupling.

The door 120 has an inner volume formed between the panel 170 and the panel 190. In some embodiments, contact between the flanges of the panel 170 and the flanges of the panel 190 extends around the entire perimeter of the door 120. Any additional holes or gaps in the door 20 may be filled with fasteners or welded shut, or otherwise sealed to seal the inner volume of the door 120 from the surrounding atmosphere. This obstructs (e.g., prevents) moisture and other contaminants from entering the door 120. In some embodiments, the door 120 includes a filler or strengthening material (e.g., honeycomb) positioned within the inner volume of the door 120, strengthening the door 120. In some embodiments, the filler or strengthening material is attached (e.g., glued, epoxied, etc.) to one or more parts of the door (e.g., both the panel 170 and the panel 190). By attaching the filler or strengthening material to one or more other parts of the door, the entire door 120 is strengthened, and the filler or strengthening material is securely held in place within the inner volume. In other embodiments, the filler or strengthening material is simply disposed within the inner volume of the door.

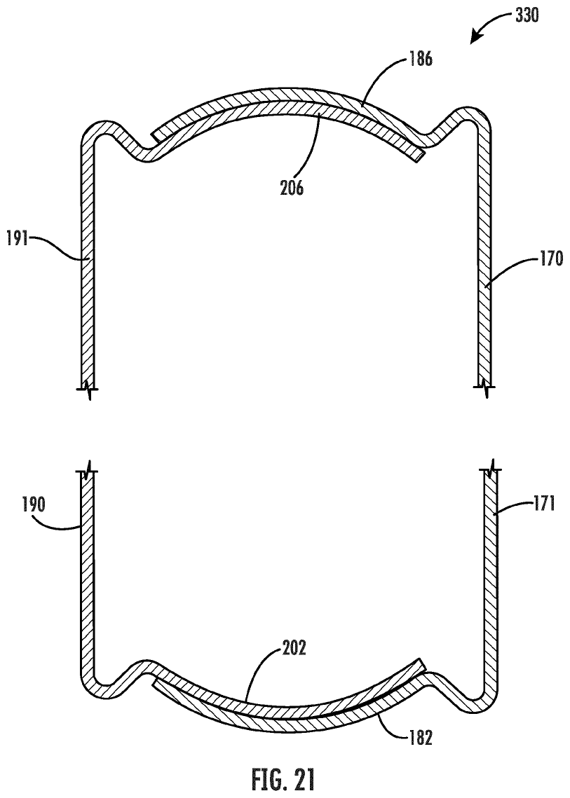

Referring to FIG. 4, the construction of the pilaster 110 is shown according to an exemplary embodiment. In some embodiments, the pilaster 112 has a similar construction to the pilaster 110. In this embodiment, the pilaster 110 includes a pair of interlocking panels, bodies, or assemblies, shown as panel 250 and 270. The panel 250 and the panel 270 may have a similar flanged construction (e.g., utilizing interlocking curved flanges) to other embodiments described herein (e.g., the panel 170 and the panel 190 of the door 330 shown in FIG. 21). As shown, the panel 250 includes a main body 251 having a side edge 252 and a side edge 254 positioned opposite one another. A side flange 262 extends along the side edge 252, and a side flange 264 extends along the side edge 254. The panel 270 includes a main body 271 having a side edge 272 and a side edge 274 positioned opposite one another. A side flange 282 extends along the side edge 272, and a side flange 284 extends along the side edge 274. The side flange 282 and the side flange 284 engage the side flange 262 and the side flange 264, respectively, to couple the panel 250 to the panel 270.

In the embodiment shown in FIGS. 3-6, the door 120 opens inward, and the hinges 122 and 124 are mounted on the left side of the door 120. Accordingly, the strip 132 is positioned on the exterior side 104 of the door 120, and the strip 130 is positioned on the interior side 102 of the door 120 to provide clearance when opening the door 120 inward. In other embodiments, the door 120 is otherwise arranged. FIG. 17 illustrates one such embodiment. In the embodiment of FIG. 17, the door 120 opens outward. Accordingly, the strip 132 is positioned on the interior side 102 of the door 120, and the strip 130 is positioned on the exterior side 104 of the door 120 to provide clearance when opening the door 120 outward. In other embodiments, the hinges 122 and 124 are mounted on the right side of the door 120. In some embodiments, the inset portions 242 are formed by the panel 190, and the inset portions 242 extend along the inner surfaces of the bottom flange 182 and the top flange 186.

Described hereinafter are additional features that may be utilized with the partition system 100 and/or the door 120. It should be understood that that any element disclosed in one embodiment may be incorporated or utilized with any other embodiment disclosed herein. For example, any of the features shown and described with reference to FIGS. 18-37 may be utilized with the partition system 100 and/or the door 120.

### Alternative Top Flange and Bottom Flange Configurations

Referring to FIG. 18, a door 290 is shown according to another exemplary embodiment. The door 290 illustrates a modification to the door 120 of FIGS. 9-16. The door 290 may be substantially similar to the door 120 unless otherwise specified. The door 290 omits the bottom flange 182, the top flange 186, the bottom flange 202, and the top flange 206. Instead, the door 290 includes a pair of stoppers or plugs, shown as caps 292. One cap 292 is positioned along the top of the door 120 and defines a top surface of the door 290. Another cap 292 is positioned along the bottom of the door 290 and defines a bottom surface of the door 290. Each cap 292 is partially inserted into the door 290 between the main body 171 and the main body 191. The caps 292 may each include a stop or shoulder 294 that engages the main body 171 and/or the main body 191 to limit the insertion depth of the cap 292 into the door 290. Each cap 292 may form a seal against the panel 170 and the panel 190. The cap 292 may be held in place by a press fit or through another type of coupling (e.g., adhesive). In some embodiments, the caps 292 are made from a different material than the panel 170 and the panel 190. By way of example, the panel 170 and the panel 190 may be steel, and the caps 292 may be aluminum or plastic.

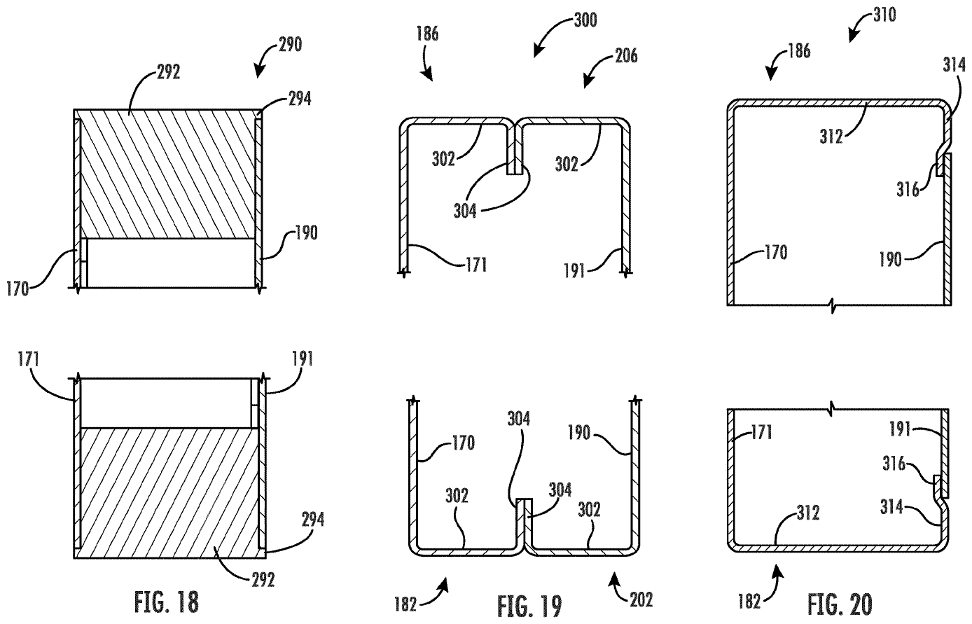

Referring to FIG. 19, a door 300 is shown according to another exemplary embodiment. The door 300 illustrates a modification to the door 120 of FIGS. 9-16. The door 300 may be substantially similar to the door 120 unless otherwise specified. In the door 300, each of the bottom flange 182, the top flange 186, the bottom flange 202, and the top flange 206 include a first portion, shown as middle portion 302, and a second portion, shown as distal portion 304. The middle portion 302 extends inward from the corresponding main body (e.g., the main body 171 or the main body 191) and couples the distal portion 304 to the corresponding main body. The middle portions 302 extend substantially perpendicular to the main bodies 171 and 191. The distal portions 304 extend substantially parallel to the main bodies 171 and 191. The distal portions 304 of the bottom flange 182 and the top flange 186 are offset inward from the main body 171. The distal portions 304 of the bottom flange 202 and the top flange 206 are offset inward from the main body 191. The distal portion 304 of the bottom flange 182 and the distal portion 304 of the bottom flange 202 engage one another and may be fixedly coupled to one another (e.g., using adhesive, etc.). The distal portion 304 of the top flange 186 and the distal portion 304 of the top flange 206 engage one another and may be fixedly coupled to one another (e.g., using adhesive, tape, a weld, etc.). Additionally and in this embodiment, the portions 304 may also engage, at least partly, around all four sides of the door.

Referring to FIG. 20, a door 310 is shown according to another exemplary embodiment. The door 310 illustrates a modification to the door 120 of FIGS. 9-16. The door 310 may be substantially similar to the door 120 unless otherwise specified. The door 310 omits the bottom flange 202 and the top flange 206. In the door 310, each of the bottom flange 182 and the top flange 186 include a first portion, shown as middle portion 312, a second portion, shown as exposed portion 314, and a third portion, inner portion, covered portion, or jogged portion, shown as inset portion 316. The middle portion 312, the exposed portion 314, and the inset portion 316 are formed as a single, continuous piece (e.g., a bent piece of sheet metal). Each middle portion 312 extends away from the main body 171 and couples the exposed portion 314 to the main body 171. The middle portions 312 extend substantially perpendicular to the main body 171. The middle portions 312 define a top surface and a bottom surface of the door 310.

The exposed portion 314 and the inset portion 316 are both substantially parallel to the main body 171. The exposed portion 314 extends between the middle portion 312 and the inset portion 316, coupling the inset portion 316 to the middle portion 312. The inset portion 316 is offset inward from the exposed portion 314 by the thickness of the material used to form the panel 190. When assembled, the inset portions 316 extend along an inner surface of the main body 191. As the inset portions 316 abut the main body 191, the inset portions 316 may be fixedly coupled to the main body 191 though welding (e.g., plug welding, laser welding, etc.), adhesive (e.g., epoxy, glue, etc.), fasteners (e.g., rivets, screws, etc.), or another type of coupling.

Referring to FIG. 21, a door 330 is shown according to another exemplary embodiment. The door 330 illustrates a modification to the door 120 of FIGS. 9-16. The door 330 may be substantially similar to the door 120 unless otherwise specified. In the door 330, the bottom flange 182, the top flange 186, the bottom flange 202, and the top flange 206 are each curved such that an inner surface of each flange is concave and an outer surface of each flange is convex. In other words, each flange extends outward, away from the center of the door 120, then subsequently inward toward the center of the door 120 as the flanges extend from the corresponding main body. The top flange 206 engages the inner surface of the top flange 186. Similarly, the bottom flange 202 engages the inner surface of the bottom flange 182. Accordingly, the top flange 206 and the bottom flange 202 are received between the top flange 186 and the bottom flange 182. Engagement between the curved surfaces of the flanges resists relative lateral movement of the panels 170 and 190, holding the panels 170 and 190 together. In other embodiments, the top flange 186 and the bottom flange 182 are received between the top flange 206 and the bottom flange 202. This configuration/arrangement can extend to both sides thereby being the same or substantially the same all the way around the door.

### Alternative Side Flange Configurations-Integrally-Formed No-Sight Strips

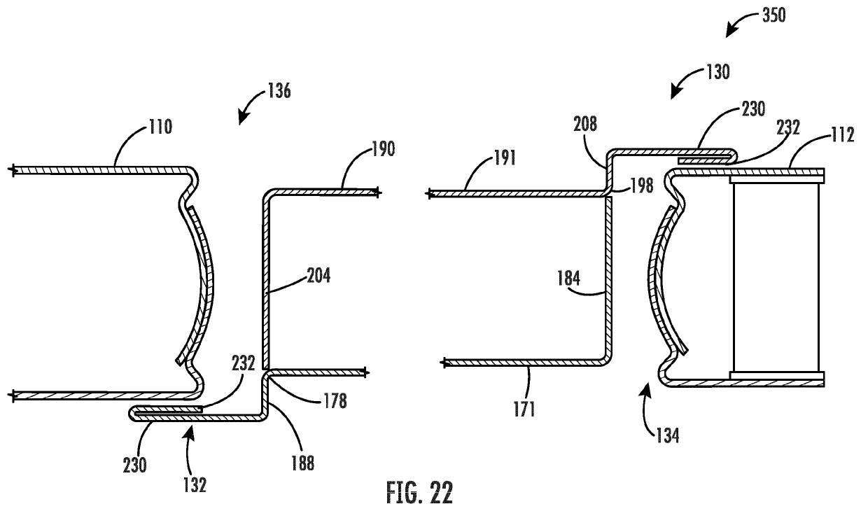

Referring to FIG. 22, a door 350 is shown according to another exemplary embodiment. The door 350 illustrates a modification to the door 120 of FIGS. 9-16. The door 350 may be substantially similar to the door 120 unless otherwise specified. In the door 350, the side flange 184 and the side flange 204 are substantially straight (e.g., each include a single straight portion). The distal end of the side flange 184 is positioned adjacent (e.g., abuts) the side edge 198. In some embodiments, the distal end of the side flange 184 is directly coupled to the side edge 198 (e.g., through welding). The distal end of the side flange 204 is positioned adjacent (e.g., abuts) the side edge 178. In some embodiments, the distal end of the side flange 204 is directly coupled to the side edge 178 (e.g., through welding).

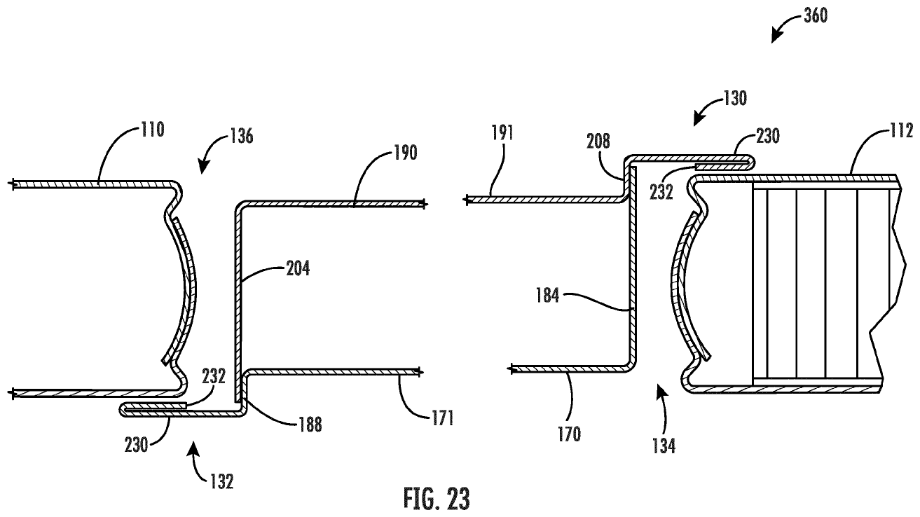

Referring to FIG. 23, a door 360 is shown according to another exemplary embodiment. The door 360 illustrates a modification to the door 120 of FIGS. 9-16. The door 360 may be substantially similar to the door 120 unless otherwise specified. In the door 360, the side flange 184 and the side flange 204 are substantially straight (e.g., each include a single straight portion). A distal end portion of the side flange 184 extends along (e.g., abuts) the side flange 208 of the panel 190. In some embodiments, the distal end portion of the side flange 184 is directly coupled to the side flange 208 (e.g., through welding, adhesive, etc.). A distal end portion of the side flange 204 extends along (e.g., abuts) the side flange 188. In some embodiments, the distal end portion of the side flange 204 is directly coupled to the side flange 188 (e.g., through welding, adhesive, etc.).

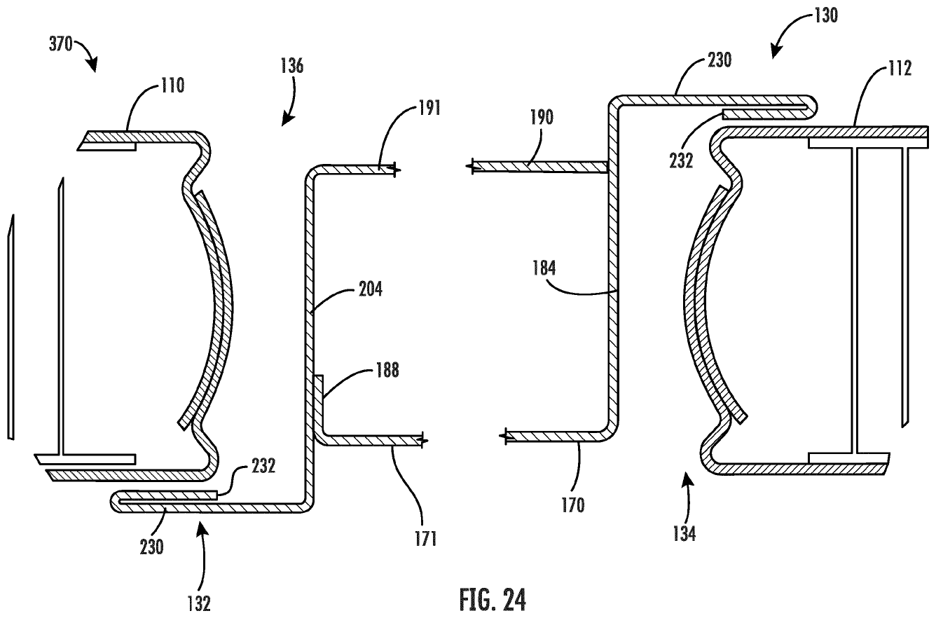

Referring to FIG. 24, a door 370 is shown according to another exemplary embodiment. The door 370 illustrates a modification to the door 120 of FIGS. 9-16. The door 370 may be substantially similar to the door 120 unless otherwise specified. In the door 370, the strip 130 is formed as a single, continuous piece with the side flange 184. The length of the side flange 184 is sufficient to offset the strip 130 outward beyond the main body 191, such that the strip 130 extends across the lock-side gap 134 and overlaps the pilaster 112. The strip 132 is formed as a single, continuous piece with the side flange 204. The length of the side flange 204 is sufficient to offset the strip 132 outward, such that the strip 132 extends across the hinge-side gap 136 and overlaps the pilaster 110. The side flange 208 is omitted from the door 370. Instead, an end of the main body 191 is positioned adjacent (e.g., abuts) the side flange 184. In some embodiments, the end of the main body 191 is directly coupled to the side flange 184 (e.g., through welding). The side flange 188 extends inward from the main body 171. The side flange 188 extends along (e.g., abuts) the side flange 204 of the panel 190. In some embodiments, the side flange 188 is directly coupled to the side flange 204 (e.g., through welding, adhesive, etc.).

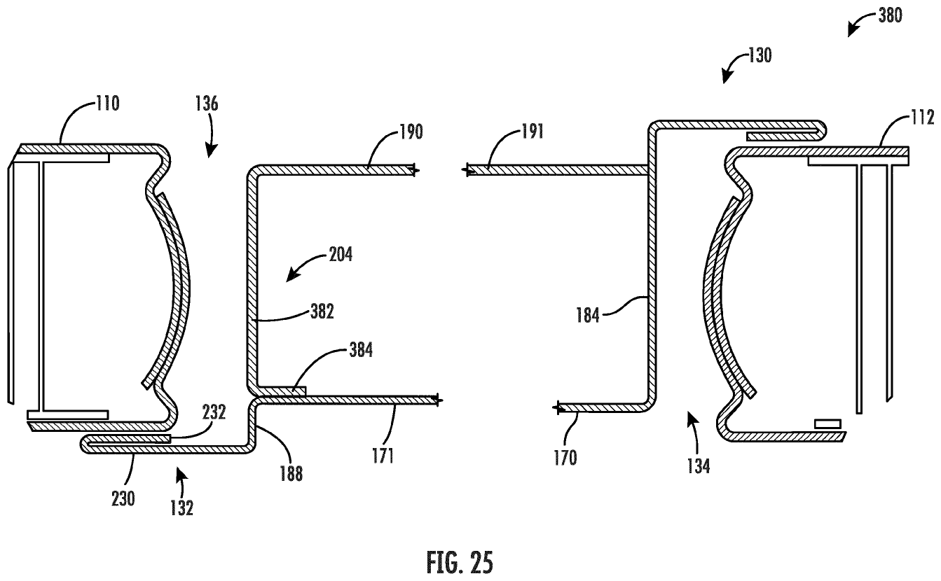

Referring to FIG. 25, a door 380 is shown according to another exemplary embodiment. The door 380 illustrates a modification to the door 120 of FIGS. 9-16. The door 380 may be substantially similar to the door 120 unless otherwise specified. In the door 380, the strip 130 is formed as a single, continuous piece with the side flange 184. The length of the side flange 184 is sufficient to offset the strip 130 outward beyond the main body 191, such that the strip 130 extends across the lock-side gap 134 and overlaps the pilaster 112. The strip 132 is formed as a single, continuous piece with the side flange 188. Accordingly, the panel 170 forms both the strip 130 and the strip 132 in the door 380. The side flange 208 is omitted from the door 380. Instead, an end of the main body 191 is positioned adjacent (e.g., abuts) the side flange 184. In some embodiments, the end of the main body 191 is directly coupled to the side flange 184 (e.g., through welding). The side flange 204 includes a first portion, shown as middle portion 382, and a second portion, shown as distal portion 384. The middle portion 382 extends inward from the main body 191 and couples the distal portion 384 to the main body 191. The middle portion 382 extends substantially perpendicular to the main body 191. The distal portion 384 extends substantially parallel to the main body 191. The distal portion 384 of the side flange 204 extends along an inner surface of the main body 171. The distal portion 384 may be fixedly coupled to the main body 171 (e.g., through welding, adhesive, etc.).

### Alternative Side Flange Configurations-Separately-Formed No-Sight Strips

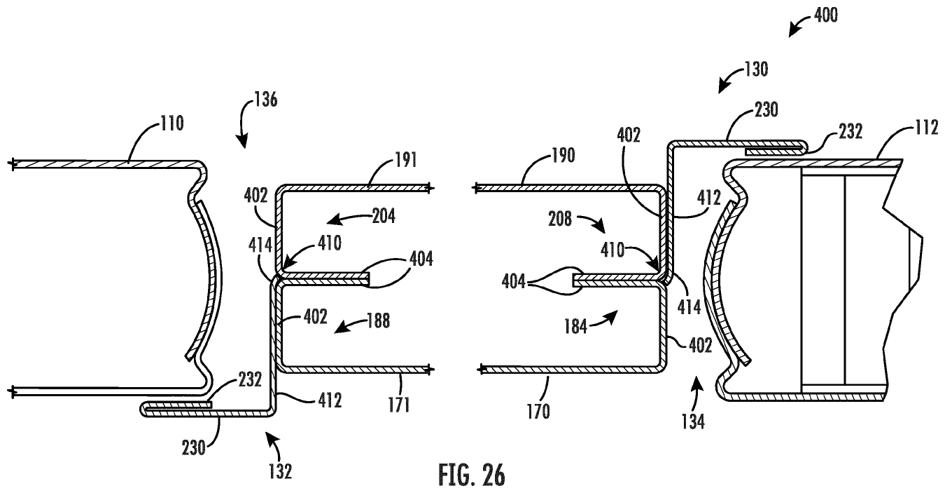

Referring to FIG. 26, a door 400 is shown according to another exemplary embodiment. The door 400 illustrates a modification to the door 120 of FIGS. 9-16. The door 400 may be substantially similar to the door 120 unless otherwise specified. In the door 400, each of the side flange 184, the side flange 188, the side flange 204, and the side flange 208 include a first portion, shown as middle portion 402, and a second portion, shown as distal portion 404. The middle portion 402 extends inward from the corresponding main body (e.g., the main body 171 or the main body 191) and couples the distal portion 404 to the corresponding main body. The middle portions 402 extend substantially perpendicular to the main bodies 171 and 191. The distal portions 404 extend substantially parallel to the main bodies 171 and 191. The distal portions 404 of the side flange 184 and the side flange 188 are offset inward from the main body 171. The distal portions 404 of the side flange 184 and the side flange 188 are offset inward from the main body 191. The distal portion 404 of the side flange 184 and the distal portion 404 of the side flange 208 engage one another and may be fixedly coupled to one another (e.g., using adhesive, etc.). The distal portion 404 of the side flange 188 and the distal portion 404 of the side flange 204 engage one another and may be fixedly coupled to one another (e.g., using adhesive, etc.).

At the transition between the middle portion 402 and the distal portion 404, each side flange forms a curved portion, radiused portion, or fillet. This radiused portion may be formed when bending the panel 170 or the panel 190 to form the side flange. Each adjacent pairs of these radiused portions forms a recess 410 adjacent the position where the distal portions 404 meet.

In the door 400, the strip 130 and the strip 132 are each formed as separate components that are coupled to the panel 170 and/or the panel 190. The strip 130 and the strip 132 each include a flat portion 230, a folded portion 232, a flat portion, shown as attachment portion 412, and an end portion, shown as radiused portion 414, all integrally formed as a single, continuous piece. In some embodiments, the strip 130 and the strip 132 are each formed as a piece of bent sheet metal (e.g., steel, aluminum, etc.). The attachment portion 412 extends substantially perpendicular to the flat portion 230. The radiused portion 414 is coupled to the attachment portion 412 at an end opposite the flat portion 230.

During assembly of the door 400, the strip 130 is coupled to the panel 190. Specifically, the attachment portion 412 of the strip 130 may be coupled to the middle portion 402 of the side flange 208 (e.g., using adhesive, laser welding, rivets, etc.). The attachment portion 412 of the strip 130 and the middle portion 402 of the side flange 208 may both be substantially flat, such that the attachment portion 412 extends along the middle portion 402. When the strip 130 is coupled to the panel 190, the radiused portion 414 may be received within the recess 410 formed by the side flange 208. In some embodiments, the radiused portion 414 is sized to have a radius that corresponds with (e.g., is substantially equal to) the radius of the recess 410. By including the radiused portion 414, the edge of the strip 130 can be hidden within the recess 410 and improve the aesthetics of the door 400. The strip 132 may be similarly arranged relative to the panel 170.

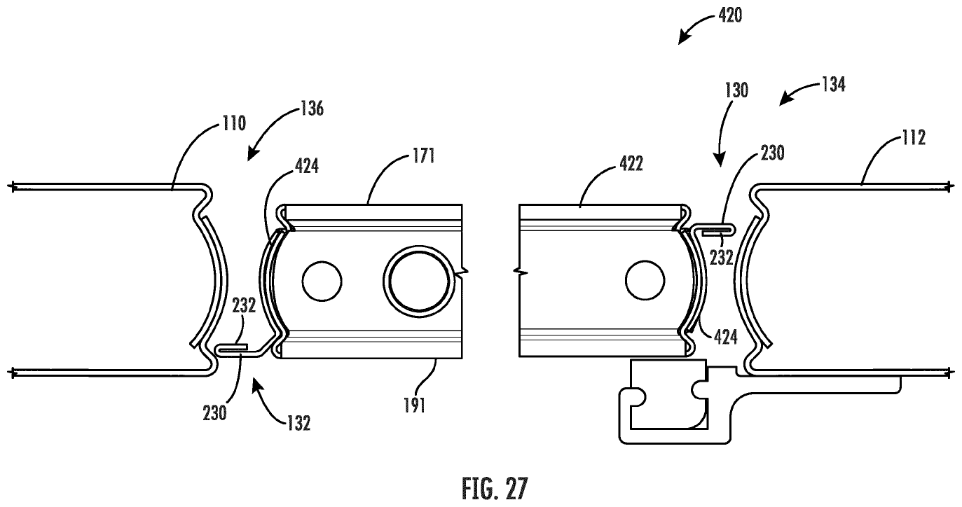

Referring to FIG. 27, a door 420 is shown according to another exemplary embodiment. The door 420 illustrates a modification to the door 120 of FIGS. 9-16. The door 420 may be substantially similar to the door 120 unless otherwise specified. In the door 420, the strip 130 and the strip 132 are each formed as separate components that are coupled to a main door portion 422. The main door portion 422 may include the panel 170 and/or the panel 190. The strips 130 and 132 each include a flat portion 230, a folded portion 232, and a curved portion, shown as attachment portion 424, all integrally formed as a single, continuous piece. In some embodiments, the strip 130 and the strip 132 are each formed as a piece of bent sheet metal (e.g., steel, aluminum, etc.).

The attachment portion 424 is coupled to a left side or a right side of the main door portion 422 (e.g., using adhesive, laser welding, rivets, etc.). In some embodiments, the attachment portion 424 is curved or otherwise shaped to match a profile or shape of the main door portion 422. Such a shape may facilitate attachment of the strips 130 and 132 to the main door portion 422.

The strip 132 is positioned between the main door portion 422 and the pilaster 110. In some embodiments, the strip 132 is contained entirely within the hinge-side gap 136, such that the strip 130 does not overlap the pilaster 110. In other embodiments, the strip 132 extends beyond the hinge-side gap 136 (e.g., outside of). The strip 130 is positioned between the main door portion 422 and the pilaster 112. In some embodiments, the strip 130 is contained entirely within the lock-side gap 134, such that the strip 132 does not overlap the pilaster 112. In other embodiments, the strip 130 extends beyond (e.g., outside of) the lock-side gap 134.

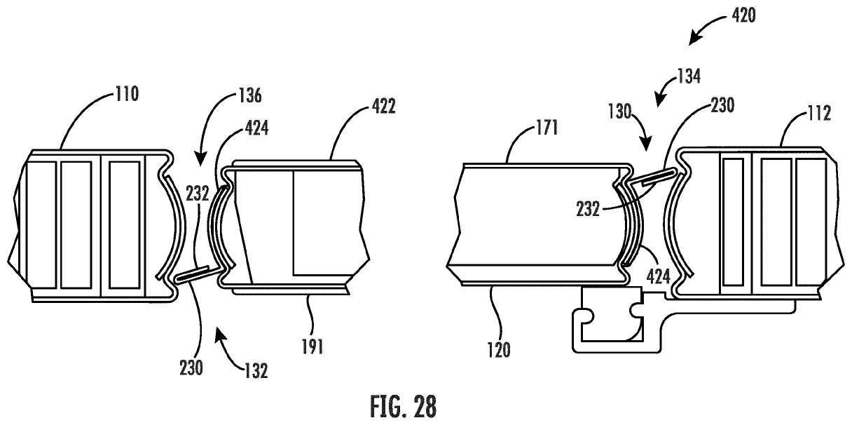

As shown in FIG. 27, the flat portion 230 of the strip 130 and the flat portion 230 of the strip 132 both extend substantially parallel to the main door portion 422 (e.g., to the main body 171 and the main body 191). FIG. 28 illustrates an alternative configuration of the door 420 in which the flat portion 230 of the strip 130 and the flat portion 230 of the strip 132 are oriented such that the flat portion 230 of the strip 130 and the flat portion 230 of the strip 132 are not parallel to the main door portion 422 (e.g., to the main body 171 and the main body 191). In FIG. 28, a plane containing the flat portion 230 of the strip 130 intersects a plane containing the main body 171 and a plane containing the main body 191. In FIG. 28, a plane containing the flat portion 230 of the strip 132 intersects the plane containing the main body 171 and the plane containing the main body 191.

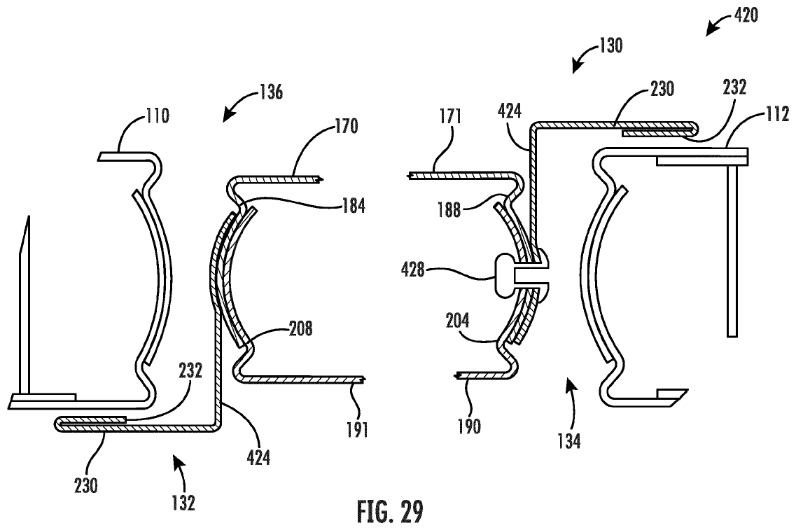

FIG. 29 illustrates an alternative configuration of the door 420. In this configuration, the lengths of the attachment portions 424 are relatively longer compared to the configuration of FIG. 27. Accordingly, the strip 132 extends out of the hinge-side gap 136 and overlaps the pilaster 110. The strip 130 extends out of the lock-side gap 134 and overlaps the pilaster 112. The door 420 of FIG. 29 further includes a fastener, shown as rivet 428, that extends through apertures defined by the attachment portion 424 of the strip 130, the side flange 188, and the side flange 204 to couple the strip 132 to the main door portion 422.

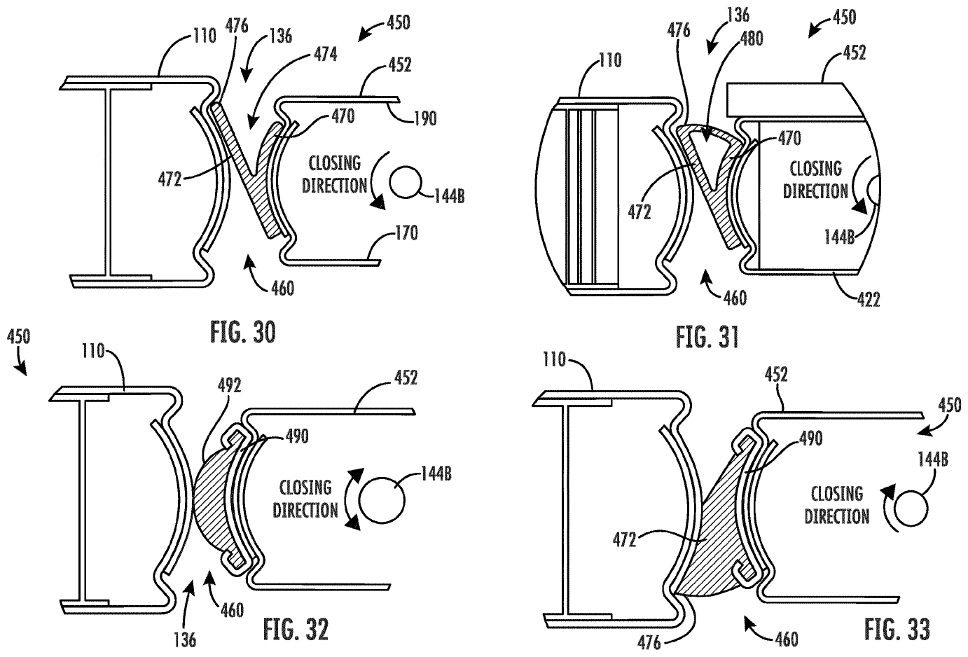

Referring to FIGS. 30-35, a door 450 is shown according to various exemplary embodiments. The doors 450 of FIGS. 30-35 illustrate modifications to the door 120 of FIGS. 9-16. The doors 450 of FIGS. 30-35 may be substantially similar to the door 120 unless otherwise specified. In FIGS. 30-35, the door 450 includes a compliant member, shown as compliant strip 460. The compliant strip 460 acts as the strip 130 and/or the strip 132 when the door 450 is closed, extending across a gap (e.g., the hinge-side gap 136 or the lock-side gap 134) to block a line of sight between the door 450 and a pilaster (e.g., the pilaster 110 or the pilaster 112). Although certain figures may illustrate a single compliant strip 460 to avoid cluttering the figures, it should be understood that another similar compliant strip 460 may be utilized simultaneously on the opposing side of the door 450. By way of example, FIG. 30 illustrates a compliant strip 460 positioned on the left side of the door 450 and extending across the hinge-side gap 136. It should be understood that the door 450 may also include another similar compliant strip 460 on the right side of the door 450 that extends across the lock-side gap 134. The compliant strip 460 on the right side of the door 450 may be inverted relative to the compliant strip 460 on the left side of the door 450 such that both compliant strips 460 have similar interactions with the corresponding pilasters 110, 112. In FIGS. 30-35, the direction that the door 450 moves when moving toward the closed position is shown as “Closing Direction.” In other embodiments, the door 450 is configured such that the closing direction is reversed.

Referring to FIG. 30, a door 450 includes a main door portion 452 and a compliant strip 460 coupled to the main door portion 452. The main door portion 452 may include the panel 170 and/or the panel 190. The compliant strip 460 of FIG. 30 includes a base portion, shown as attachment portion 470, that is coupled to an extension portion, interactive portion, or interface portion, shown as arm 472. The attachment portion 470 and the arm 472 are formed from a single, continuous piece of compliant material (e.g., rubber, plastic, etc.).

The attachment portion 470 is coupled to a side of the main door portion 452 (e.g., a side facing a pilaster, a side flange of one of the panels, etc.). By way of example, the attachment portion 470 may be covered (e.g., backed) with adhesive that adheres to the main door portion 452. A gap, shown as recess 474, is formed between the arm 472 and the attachment portion 470. The recess 474 is open along the top, bottom, and front sides of the compliant strip 460. The recess 474 may facilitate deformation of the arm 472.

When the door 450 is moved from an open position to a closed position, an end of the arm 472 (e.g., an end of the arm 472 distal from the attachment portion 470), shown as contact end 476, moves toward the pilaster 110. When the contact end 476 engages the pilaster 110, the arm 472 begins to deform, compressing the compliant strip 460. Because the compliant strip 460 is made from a compliant material, this compression causes only elastic deformation in the compliant strip 460. If the hinge-side gap 436 widens as the door 450 approaches the closed position, and the compliant strip 460 expands to fill the hinge-side gap 136. Accordingly, the compliant strip 460 eliminates any potential lines of sight between the main door portion 452 and the pilaster 110.

FIG. 31 illustrates an alternative configuration of the compliant strip 460. In this embodiment, the arm 472 encloses the recess 474, such that the arm 472 defines a passage 480. The passage 480 may permit elastic deformation of the arm 472. The compliant strip 460 of FIG. 31 may have a greater resistance to compression than the compliant member of FIG. 30.

FIG. 32 illustrates another alternative configuration of the compliant strip 460. In this embodiment, the compliant strip 460 includes an attachment portion or base portion, shown as metal backing 490, and an extension portion, interactive portion, or interface portion, shown as dome 492. The metal backing 490 couples the compliant strip 460 to the main door portion 452. By way of example, the metal backing 490 may be fastened or adhered to the main door portion 452. The metal backing 490 may wrap around the dome 492 to fixedly couple the dome 492 to the metal backing.

The dome 492 may be made from a compliant material (e.g., rubber, plastic, etc.). In some embodiments, the material of the dome 492 is more compliant (e.g., softer, less resistant to compression, etc.) than the material of the metal backing 490. The dome 492 may perform a similar function to the arm 472. The dome 492 has a substantially semispherical cross-sectional shape. Accordingly, the dome 492 is substantially symmetrical about a center plane of the door 450. This symmetry may permit equal performance of the compliant strip 460, regardless of whether or not the closing direction is reversed.

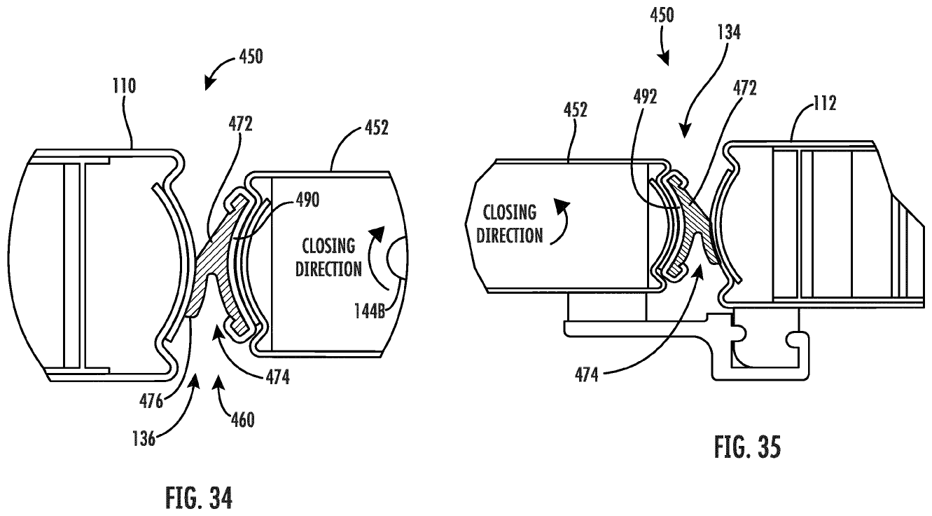

FIG. 33 illustrates another alternative configuration of the compliant strip 460. In this embodiment, the arm 472 is coupled to the main door portion 452 by the metal backing 490. The passage 480 is eliminated, and the arm 472 is completely solid. Additionally, the orientations of the arm 472 and the closing direction are reversed relative to FIGS. 30 and 31. FIG. 34 illustrates another alternative configuration of the compliant strip 460. This embodiment is substantially similar to the embodiment of FIG. 33, except the arm 472 is provided with the recess 474.

FIG. 35 illustrates another alternative configuration of the compliant strip 460. This embodiment is substantially similar to the embodiment of FIG. 34, except the compliant strip 460 engages the pilaster 112. Additionally, the orientation of the arm 472 relative to the closing direction is reversed relative to FIG. 34.

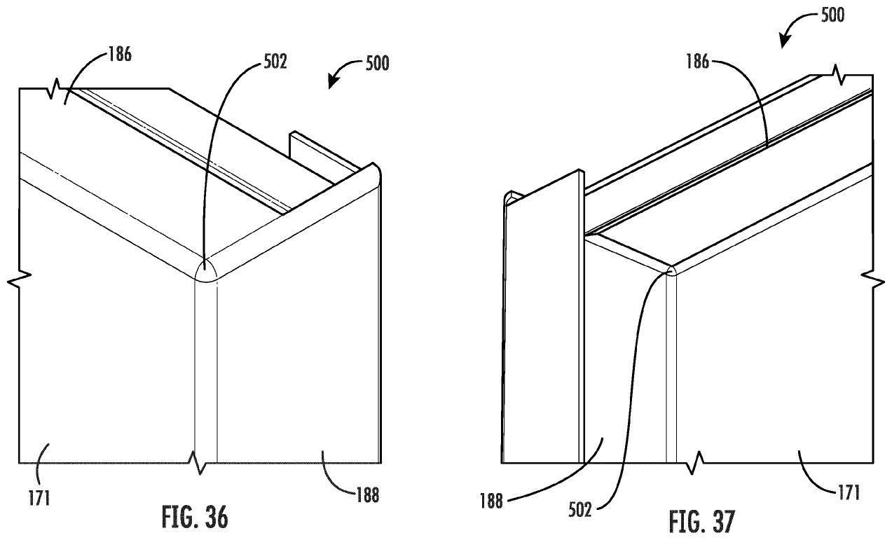

FIGS. 36 and 37, a panel 500 is shown according to another exemplary embodiment. The panel 500 illustrates a modification to the panel 170 of FIGS. 9-16. The panel 500 may be substantially similar to the panel 170 of the door 120 unless otherwise specified. The panel 500 illustrates possible method for manufacturing a panel having two adjacent flanges. As shown in FIG. 11, the top flange 186 and the side flange 188 are positioned adjacent one another. In some embodiments, a gap is formed between the top flange 186 and the side flange 188. By way of example, such a gap may be formed by individually bending the top flange 186 and the side flange 188 relative to the main body 171. However, such a gap may not be desirable, as it may provide a point of ingress for debris into the door 120.

To combat this, the panel 500 is manufactured with a formed corner 502 between the top flange 186, the side flange 188, and the main body 171. These three features meet at the formed corner 502 without any seams (e.g., (a) the top flange 186 is directly and continuously connected to the side flange 188 and the main body 171, (b) the side flange 188 is directly and continuously connected to the top flange 186 and the main body 171, and (c) the main body 171 is directly and continuously connected to the top flange 186 and the side flange 188). The formed corner 502 may be manufactured using a sheet metal forming process, such as deep drawing. Although the formed corner 502 between the top flange 186, the side flange 188, and the main body 171 is discussed herein, it should be understood that the formed corner 502 may be utilized in any embodiment where three features meet at a common corner.

### Alternative Partition System Configurations

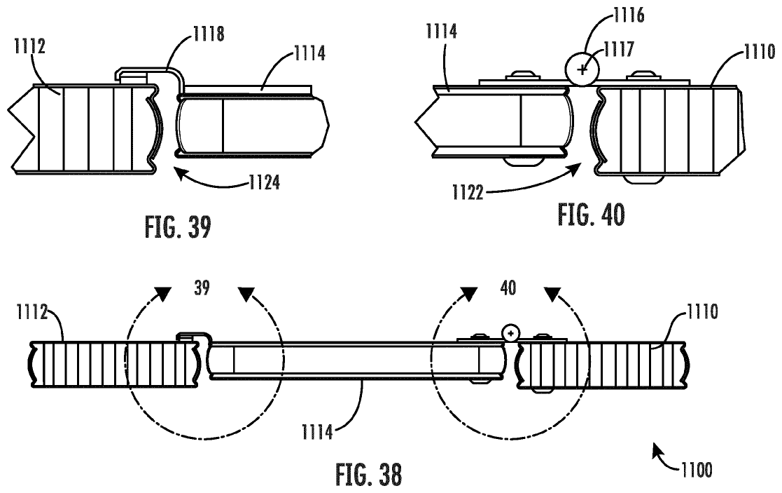

Referring to FIGS. 38-42, a partition system 1100 is shown according to another exemplary embodiment. The partition system 1100 illustrates a modification to the partition system 100. The partition system 1100 may be substantially similar to the partition system 100 unless otherwise specified. The partition system 1100 is another example of the partition system 30.

The partition system 1100 has an interior side 1102 that faces inward toward the stall 12 and an exterior side 1104 that faces outward, away from the stall 12. The partition system 1100 includes a pair of pilasters (e.g., faces, stiles, dividers, panels, wall members, etc.), shown as pilaster 1110 and pilaster 1112. A door subassembly, shown as door 1114, is pivotally coupled to the pilaster 1110 by a hinge assembly, shown as hinge 1116, such that the door 1114 rotates about an axis 1117 that extends substantially vertically through the center of the hinge 1116. As shown, the door 1114 opens inward, and the hinge 1116 is positioned on the left side of the door 1114 as viewed from within the stall. In other embodiments, the door 1114 opens outwards, and/or the hinge 1116 is positioned on the right side of the door 1114 as viewed from within the stall. The door 1114 includes a no-sight strip, flange, extension, member or element, protrusion, sight blocker, sight obscurer, or privacy screen, shown as strip 1118, positioned on a side of the door 1114 opposite the hinge 1116. A lock assembly, latch assembly, indicator, indicator latch, or handle, shown as lock assembly 1120, selectively couples the door 1114 to the pilaster 1112 to selectively prevent movement of the door 1114 out of the closed position. The dimensions of the partition system 1100 shown in FIGS. 38-42 are exemplary only and are not intended to be limiting. In other embodiments, the partition system 1100 is otherwise dimensioned. By way of example, the door 1114 may have a different height and/or width depending upon the desired size of the stall.

A first space or gap, shown as hinge-side gap 1122, extends and is defined between the door 1114 and the pilaster 1110 when the door 1114 is in the closed position. Accordingly, the hinge-side gap 1122 extends along a side of the door 1114 closest to the hinge 1116 (i.e., opposite the lock assembly 1120). A second space or gap, shown as lock-side gap 1124, extends and is defined between the door 1114 and the pilaster 1112 when the door 1114 is in the closed position. Accordingly, the lock-side gap 1124 extends along a side of the door 1114 closest to the lock assembly 1120 (i.e., opposite the hinge 1116). Conventionally, the hinge-side gap 1122 and the lock-side gap 1124 would be uncovered, permitting an observer located outside the stall to look therethrough, at a detriment to the privacy of a user located within the stall. Instead, the hinge 1116 extends across the hinge-side gap 1122, and the strip 1118 extends across the lock-side gap 1124, preventing sight therethrough and improving the privacy of the user in the stall.

The hinge 1116 includes a first body, shown as hinge plate 1130, pivotally coupled to a second body, shown as hinge plate 1132, by a pin 1134. The hinge plate 1130 is coupled (e.g., fastened) to the pilaster 1110. The hinge plate 1132 is coupled (e.g., fastened) to the door 1114. The hinge plate 1130 and the hinge plate 1132 each define a series of interlocking hinge barrels that align within one another. The pin 1134 extends through the hinge barrels to pivotally couple the hinge plate 1130 to the hinge plate 1132. As shown, the pin 1134 extends substantially vertically. The hinge plate 1130 and the hinge plate 1132 rotate about the axis 1117, which extends through the center of the pin 1134. In the embodiment shown, the hinge 1116 is a piano hinge with closely spaced hinge barrels to minimize gaps in the hinge 1116. The hinge 1116 is coupled to the surface of the door 1114 and the pilaster 1110 such that the axis 1117 is offset rearward from the rear surfaces of the door 1114 and the pilaster 1110. In other embodiments, the hinge 1116 is otherwise shaped (e.g., with different sized gaps between the hinge barrels, with a different cross-sectional shape of hinge barrel (e.g., square, triangular, etc.), with a differently shaped (e.g., semicircular, trapezoidal, triangular, etc.) flat portion of each hinge plate, etc.).

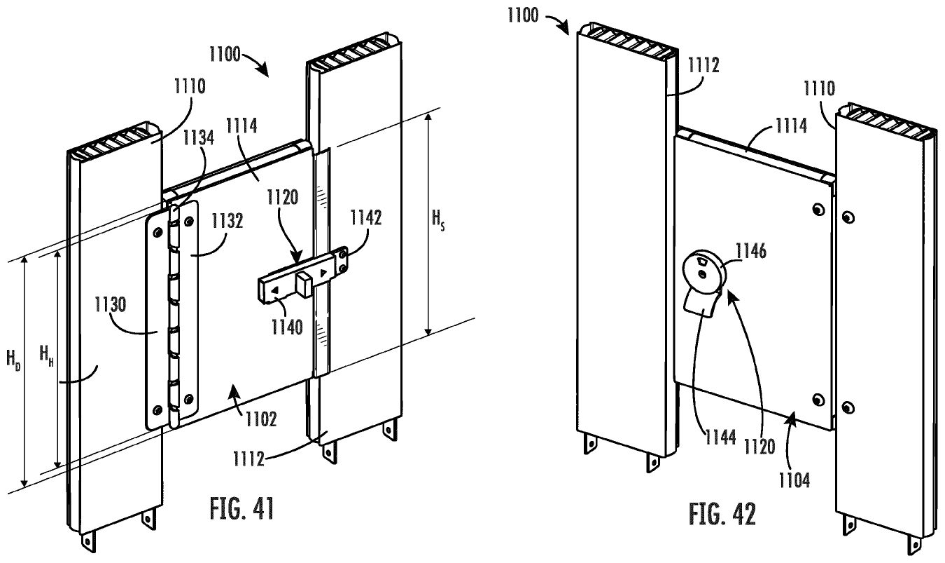

Referring to FIGS. 41 and 42, the lock assembly 1120 includes a lock or latch, shown as sliding latch 1140, that is slidably coupled to the door 1114. The sliding latch 1140 is selectively repositionable along a horizontal axis between a locked position and an unlocked position. In the locked position, the sliding latch 1140 engages a fixed component, shown as lock tab 1142, to limit (e.g., prevent) movement of the door 1114. The lock tab 1142 is coupled (e.g., fastened) to the pilaster 1112. In the open position, the sliding latch 1140 is disengaged from the lock tab 1142 such that the door 1114 is free to swing. A manipulator, grip, or handle, shown as handle 1144, is coupled to an exterior surface of the door 1114. The handle 1144 facilitates a user pulling the door 1114 toward the closed position. A vacancy indicator or visual indicator, shown as indicator 1146, is coupled to the door 1114 and the sliding latch 1140. The indicator 1146 is configured to visually indicate a status of the sliding latch 1140. By way of example, the indicator 1146 may be coupled to the sliding latch 1140 such that a movement of the sliding latch 1140 causes a corresponding movement of the indicator 1146 to expose different parts of the indicator 1146. When the sliding latch 1140 is in the locked position, a first exposed portion of the indicator 1146 may be shown, providing a first visual indication (e.g., showing the color red or the phrase “occupied”) to indicate to an observer that the stall is occupied. When the sliding latch 1140 is in the unlocked position, a second exposed portion of the indicator 1146 may be shown, providing a second visual indication (e.g., showing the color green or the phrase “vacant”) to indicate to an observer that the stall is vacant. In other embodiments, the partition system 1100 includes a different type of lock assembly 1120 (e.g., a rotating latch).

Referring to FIGS. 39-41, the door 1114 has a height H_{D} measured vertically. The hinge 1116 has a height H_{H} measured vertically. The strip 1118 has a height H_{S} measured vertically. As shown, the height H_{H} of the hinge 1116 and the height H_{S} of the strip 1118 are nearly as large as the height H_{D} of the door 1114. In various embodiments, the height H_{H} of the hinge 1116 and/or the height H_{S} of the strip 1118 may be less than, greater than, or substantially equal to the height H_{D} of the door 1114. By way of example, the height H_{H} of the hinge 1116 and the height H_{S} of the strip 1118 may be at least 0.5, 0.75, 0.8, 0.9, 0.95, 1, 1.05, 1.1, 1.2, 1.25, or 1.5 times the height H_{D} of the door 1114. Accordingly, the hinge 1116 may cover at least 50%, 75%, 80%, 90%, 95%, or 100% of the hinge-side gap 1122 or extend beyond the ends of the hinge-side gap 1122. Similarly, the strip 1118 may cover at least 50%, 75%, 80%, 90%, 95%, or 100% of the lock-side gap 1124 or extend beyond the ends of the lock-side gap 1124. In some embodiments, the height H_{H} of the hinge 1116 and the height H_{S} of the strip 1118 are substantially equal. In other embodiments, the hinge 1116 and/or the strip 1118 are taller than the door 1114 to maximize privacy without adding additional material to the door 1114. Covering large portions of the hinge-side gap 1122 and the lock-side gap 1124 is advantageous, as this minimizes the uncovered portions of the hinge-side gap 1122 and the lock-side gap 1124 that might otherwise permit a line of sight therethrough.

In other embodiments, the hinge 1116 may include multiple discrete hinges arranged vertically to cover the hinge-side gap 1122. In such an embodiment, the collective portions of the hinge-side gap 1122 covered by the individual hinges should be considered when determining the percentage of the hinge-side gap 1122 that is covered by the hinge 1116. By way of example, if the hinge 1116 included a first hinge that extended along 20% of the height H_{D} of the door 1114 and a second hinge that extended along 60% of the height H_{D} of the door 1114, the hinge 1116 would be considered to cover 80% of the hinge-side gap 1122. Similarly, in other embodiments, the strip 1118 may include multiple discrete strips arranged vertically to cover the lock-side gap 1124. In such an embodiment, the collective portions of the lock-side gap 1124 covered by the individual strips should be considered when determining the percentage of the lock-side gap 1124 that is covered by the strip 1118. By way of example, if the strip 1118 included a first strip that extended along 30% of the height H_{D} of the door 1114 and a second hinge that extended along 30% of the height H_{D} of the door 1114, the strip 1118 would be considered to cover 60% of the lock-side gap 1124.

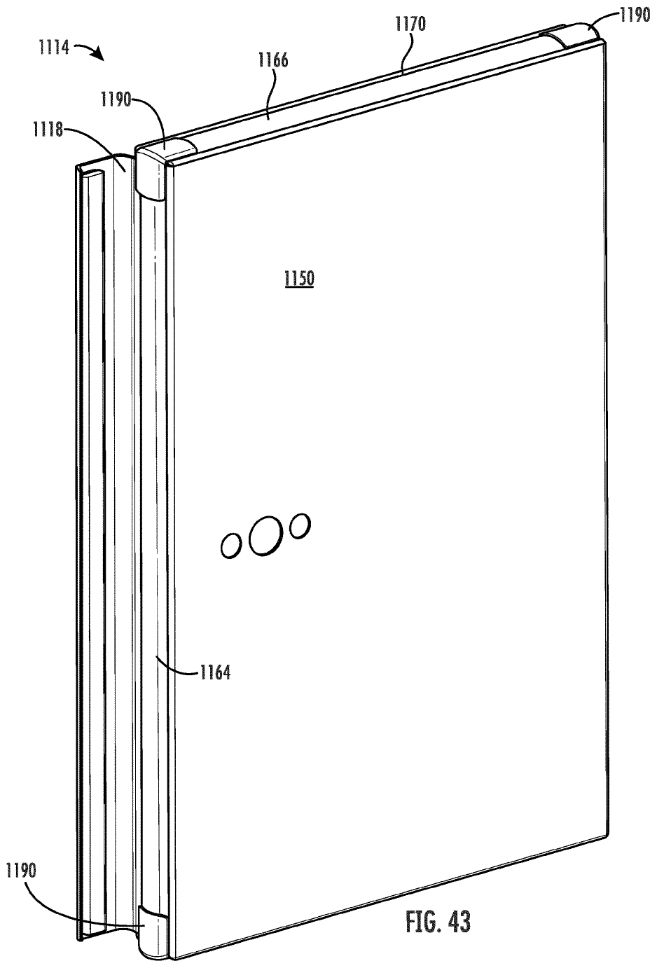

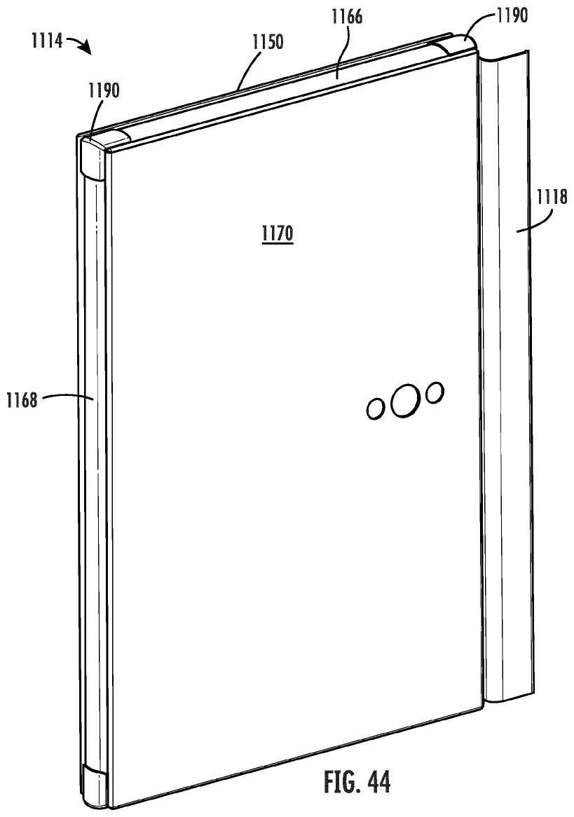

Referring to FIGS. 43 and 44, the door 1114 includes a first panel or body, shown as panel 1150, and a second panel or body, shown as panel 1170. As shown, the panel 1150 is an exterior panel (i.e., facing away from the stall), and the panel 1170 is an interior panel (i.e., faces toward the stall). In other embodiments where the door 1114 opens outward, the panel 1150 is an interior panel, and the panel 1170 is an exterior panel. The door 1114 further includes reinforcement members or covers, shown as corner brackets 1190. The strip 1118, the panel 1150, the panel 1170, and the corner brackets 1190 are fixedly coupled to one another to form the door 1114. By way of example, the strip 1118, the panel 1150, the panel 1170, and/or the corner brackets 1190 may be coupled to one another using welding (e.g., tack welding, spot welding, etc.), adhesive (e.g., epoxy, etc.), a press fit (e.g., having a wedge shaped component that is forced between two other components, etc.), interlocking components, fasteners, or other types of coupling.

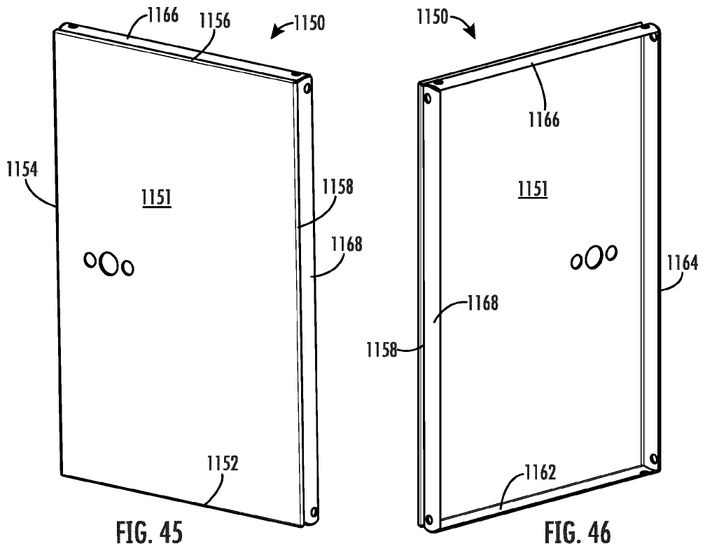

Referring to FIGS. 45 and 46, the panel 1150 is shown according to an exemplary embodiment. The panel 1150 includes a flat, rectangular body or panel, shown as main body 1151. The main body 1151 has a series of edges or contours, shown as bottom edge 1152, side edge 1154, top edge 1156, and side edge 1158. The bottom edge 1152 is positioned opposite the top edge 1156, and the side edge 1154 is positioned opposite the side edge 1158. As shown, each of the edges are substantially straight. A series of protrusions or flanges each extend away from the main body 1151 and along a corresponding edge. Specifically, a bottom flange 1162 extends along the bottom edge 1152, a side flange 1164 extends along the side edge 1154, a top flange 1166 extends along the top edge 1156, and a side flange 1168 extends along the side edge 1158. The main body 1151, the bottom flange 1162, the side flange 1164, the top flange 1166, and the side flange 1168 are formed as a single, continuous piece. By way of example, the bottom flange 1162, the side flange 1164, the top flange 1166, the side flange 1168, and the main body 1151 may be formed from a single piece of bent sheet metal. Accordingly, the panel 1150 may have a unitary construction. In other embodiments, the panel 1150 is formed from multiple separate pieces coupled to one another.

Each of the flanges of the panel 1150 are curved such that an inner surface of each flange is concave and an outer surface of each flange is convex. In other words, each flange extends outward, away from the center of the door 1114, then subsequently inward toward the center of the door 1114 as the flanges extend from the main body 1151. Accordingly, the middle of each flange extends furthest from the center of the door 1114. By way of example, an inner surface (e.g., a top surface) of the bottom flange 1162 is concave. An outer surface (e.g., a bottom surface) of the bottom flange 1162 is convex. In some embodiments, each of the flanges have substantially the same radius of curvature. In other embodiments, the flanges are otherwise shaped. By way of example, one or more of the flanges may be flat (e.g., perpendicular to the main body 1151). By way of another example, one or more of the flanges may be trapezoidal or triangular (e.g., such that the flanges have flat sections but remain concave inward). By way of another example, one or more of the flanges may be concave outward (e.g., an outer surface of each flange is concave, and/or an inner surface of each flange is convex). By way of another example, the radii of curvature of each flange may vary. By way of another example, the outer surface and the inner surface of each flange may have different shapes (e.g., flat versus curved, trapezoidal vs triangular, etc.).

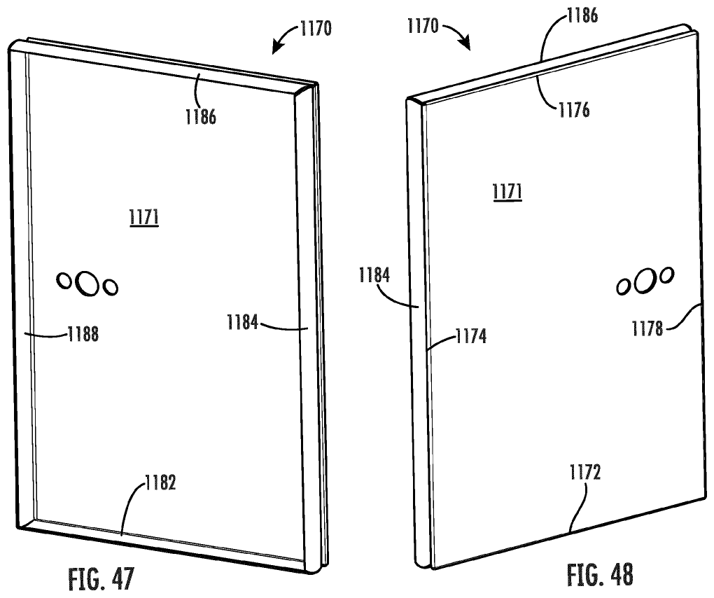

Referring to FIGS. 47 and 48, the panel 1170 is shown according to an exemplary embodiment. The panel 1170 includes a flat, rectangular body or panel, shown as main body 1171. The main body 1171 has a series of edges or contours, shown as bottom edge 1172, side edge 1174, top edge 1176, and side edge 1178. The bottom edge 1172 is positioned opposite the top edge 1176, and the side edge 1174 is positioned opposite the side edge 1178. As shown, each of the edges are substantially straight. A series of protrusions or flanges each extend away from the main body 1171 and along a corresponding edge. Specifically, a bottom flange 1182 extends along the bottom edge 1172, a side flange 1184 extends along the side edge 1174, a top flange 1186 extends along the top edge 1176, and a side flange 1188 extends along the side edge 1178. The main body 1171, the bottom flange 1182, the side flange 1184, the top flange 1186, and the side flange 1188 are formed as a single, continuous piece. By way of example, the bottom flange 1182, the side flange 1184, the top flange 1186, the side flange 1188, and the main body 1171 may be formed from a single piece of bent sheet metal. Accordingly, the panel 1170 may have a unitary construction. In other embodiments, the panel 1170 is formed from multiple separate pieces coupled to one another.

Each of the flanges of the panel 1170 are curved such that an inner surface of each flange is concave and an outer surface of each flange is convex. In other words, each flange extends outward, away from the center of the door 1114, then subsequently inward toward the center of the door 1114 as the flanges extend from the main body 1171. Accordingly, the middle of each flange extends furthest from the center of the door 1114. By way of example, an inner surface (e.g., a top surface) of the bottom flange 1182 is concave. An outer surface (e.g., a bottom surface) of the bottom flange 1182 is convex. In some embodiments, each of the flanges have substantially the same radius of curvature. In other embodiments, the flanges are otherwise shaped. By way of example, one or more of the flanges may be flat (e.g., perpendicular to the main body 1171). By way of another example, one or more of the flanges may be trapezoidal or triangular (e.g., such that the flanges have flat sections but remain concave inward). By way of another example, one or more of the flanges may be concave outward. By way of another example, the radii of curvature of each flange may vary. By way of another example, the outer surface and the inner surface of each flange may have different shapes (e.g., flat versus curved, trapezoidal vs triangular, etc.).

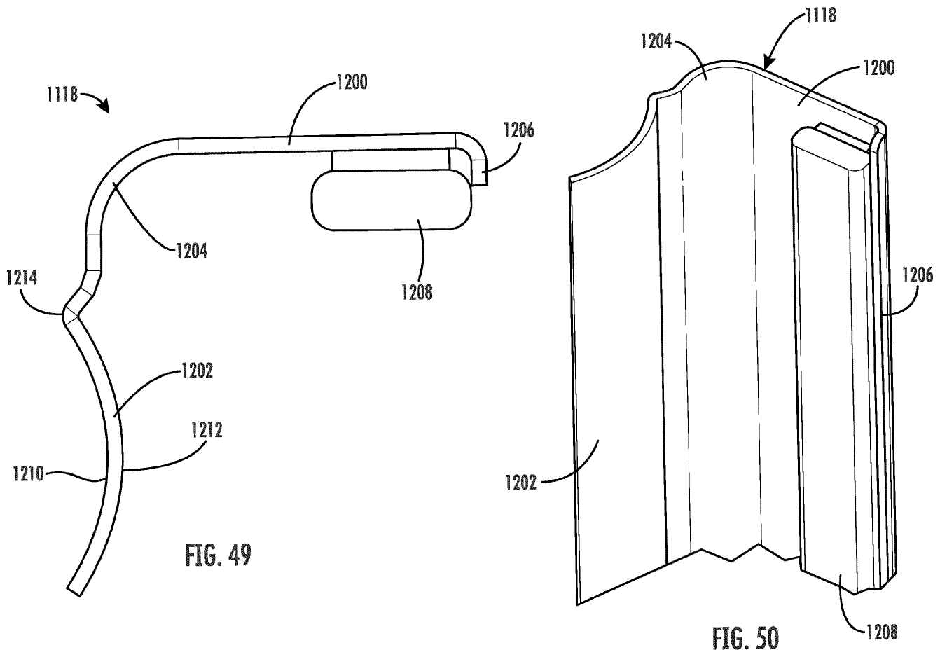

Referring to FIGS. 49 and 50, the strip 1118 is shown according to an exemplary embodiment. The strip 1118 includes a first portion (e.g., an obstructing portion, an obscuring portion, a flat portion, etc.), shown as obscuring portion 1200, a second portion (e.g., a curved portion, a mounting portion, an interface portion, etc.), shown as mounting portion 1202, and a third portion (e.g., a connecting portion, a curved portion, etc.), shown as connecting portion 1204. The connecting portion 1204 extends between and is coupled to the obscuring portion 1200 and the mounting portion 1202. An end of the obscuring portion 1200 opposite the connecting portion 1204 includes a protrusion, shown as flange 1206. The mounting portion 1202 extends generally perpendicular to the obscuring portion 1200. A sealing portion or dampener, shown as seal 1208, is coupled to the obscuring portion 1200. The seal 1208 is positioned such that the seal 1208 engages the pilaster 1112 when the door 1114 is in the closed position. The seal 1208 may be made (e.g., partially, entirely, etc.) from a compliant material, such as rubber, to form a seal against the pilaster 1112 and/or dampen a collision between the pilaster 1112 and the door 1114. In other embodiments, the strip 1118 is otherwise shaped. By way of example, the obscuring portion 1200, the mounting portion 1202, and/or the connecting portion 1204 may be flat, curved, trapezoidal, chamfered, or otherwise shaped.

The mounting portion 1202 is curved such that an inner surface 1210 of the mounting portion 1202 is concave and an outer surface 1212 of the mounting portion 1202 is convex. The connecting portion 1204 is curved such that the connecting portion 1204 and the mounting portion 1202 meet at a point, protrusion, or peak, shown as peak 1214. In other embodiments, the mounting portion 1202 is otherwise shaped (e.g., flat, tapered, trapezoidal, etc.).

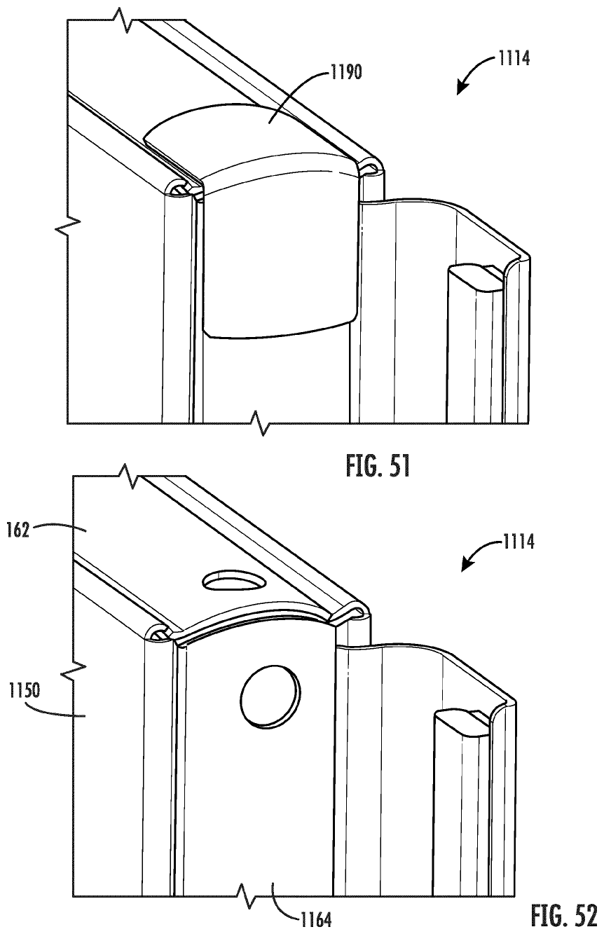

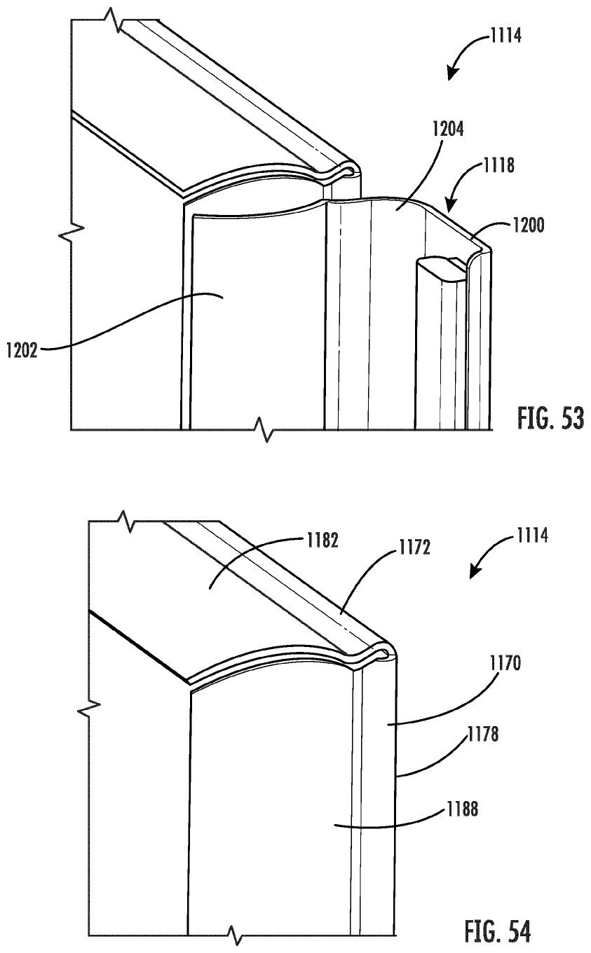

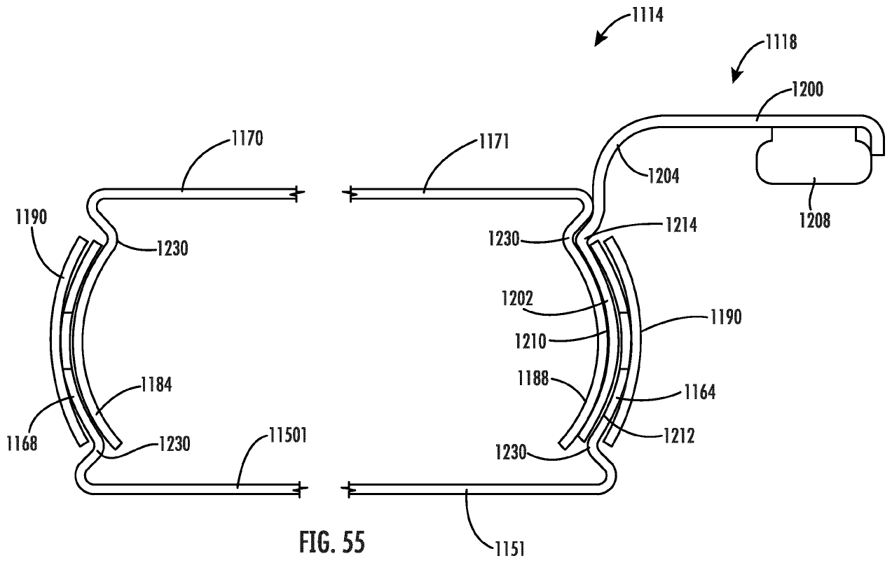

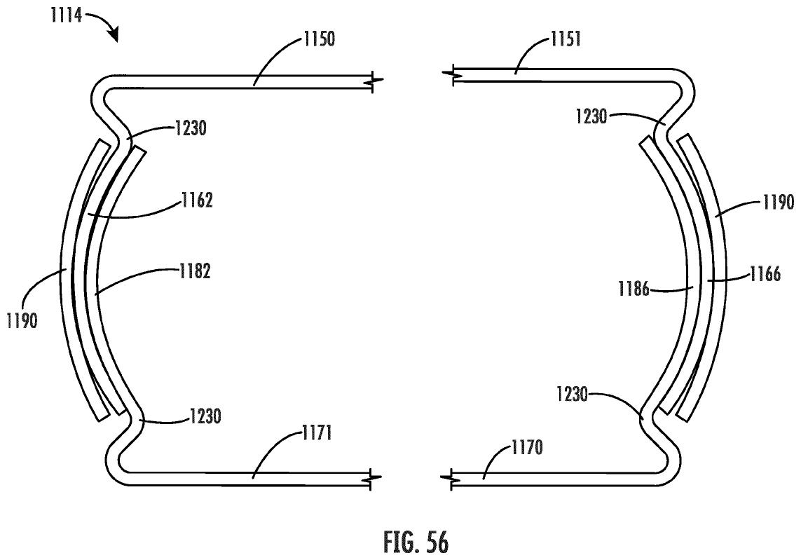

Referring to FIGS. 51-54, the door 1114 is shown at various stages of assembly. The corner bracket 1190 is the most exterior component of the door 1114. FIG. 55 shows a top sectional view of the door 1114. FIG. 56 shows another sectional view of the door 1114. The corner brackets 1190 each cover and reinforce a corner of the panel 1150. The panel 1150 is positioned inward of the corner brackets 1190. The mounting portion 1202 of the strip 1118 is positioned inward (e.g., inside) of the flanges of the panel 1150. The panel 1170 is positioned inward of the mounting portion 1202. Accordingly, the mounting portion 1202 extends directly between and is held in place by the side flange 1188 and the side flange 1164. The flanges of the panel 1170 are positioned inside of the flanges of the panel 1150. Accordingly the flanges of the panel 1170 may be considered inner flanges, and the flanges of the panel 1150 may be considered outer flanges. In other embodiments, the flanges of the panel 1170 are spaced farther apart than the flanges of the panel 1150 such that the panel 1150 is received inside the panel 1170. In some embodiments, the door 1114 includes a filler or strengthening material (e.g., honeycomb) that extends between the main body 1151 and the main body 1171, strengthening the door 1114.

The curvatures of the flanges of the panel 1150 and the panel 1170, the mounting portion 1202 of the strip 1118, and the corner brackets 1190 facilitate assembly of the door 1114. Specifically, the curvatures facilitate alignment, coupling, and sealing of these components. As shown in FIG. 55, the side flange 1188, the mounting portion 1202, the side flange 1164, and the corner bracket 1190 each have similar curvatures (e.g., are all convex inward, all have the same or similar radii of curvature). An outer surface of the side flange 1188 directly engages the inner surface 1210 of the mounting portion 1202. The outer surface 1212 of the mounting portion 1202 directly engages an inner surface of the side flange 1164. An outer surface of the side flange 1164 directly engages an inner surface of the corner bracket 1190. Similarly, the side flange 1184, the side flange 1168, and the corner bracket 1190 each have similar curvatures (e.g., are all convex inward, all have similar radii of curvature). An outer surface of the side flange 1184 directly engages an inner surface of the side flange 1168. An outer surface of the side flange 1168 directly engages an inner surface of the corner bracket 1190. Thus, the “no-sight” feature of the door 1114 includes three components: the panel 1150, the panel 1170, and the strip 1118, which is sandwiched between the panel 1150 and the panel 1170.

As shown in FIG. 56, the bottom flange 1162, the bottom flange 1182, and the corner bracket 1190 each have similar curvatures (e.g., are all convex inward, all have similar radii of curvature). An outer surface of the bottom flange 1182 directly engages an inner surface of the bottom flange 1162. An outer surface of the bottom flange 1162 directly engages an inner surface of the corner bracket 1190. Similarly, the top flange 1166, the top flange 1186, and the corner bracket 1190 each have similar curvatures (e.g., are all convex inward, all have similar radii of curvature). An outer surface of the top flange 1186 directly engages an inner surface of the top flange 1166. An outer surface of the top flange 1166 directly engages an inner surface of the corner bracket 1190. As shown, each corner bracket 1190 has a convex, curved outer surface. In other embodiments, the corner brackets 1190 are otherwise shaped (e.g., concave, flat, trapezoidal, triangular, etc.).

The flanges on one side of the door 1114 have opposing curvatures to the flanges on the opposite side of the door 1114 (e.g., are concave in opposing directions). Accordingly, as the panel 1150 is moved toward the panel 1170, the flanges of the panel 1150 push against the corresponding flanges of the panel 1170, forcing the flanges of the panel 1150 outward and forcing the flanges of the panel 1170 inward. This causes elastic deformation of the flanges, storing energy. Once the panel 1150 and the panel 1170 reach a threshold distance from one another, the flanges begin to move back to their original positions, releasing the stored energy until the curvatures are fully aligned with one another. In this position, the flanges resist deformation, thereby resisting movement of the panel 1170 away from the panel 1150 and disassembly of the door 1114.

The side flange 1188 and the side flange 1164 directly engage and press against opposing sides of the mounting portion 1202 of the strip 1118, limiting (e.g., preventing) lateral movement of the strip 1118. To further limit movement of the strip 1118, each of the flanges of the panel 1150 and the panel 1170 are formed with a bend adjacent the corresponding main body (e.g., the main body 1151 or the main body 1171). The bend has the opposite curvature of the main portion of the flange. By way of example, the curvature of the main portion of the side flange 1188 is convex inward, whereas the bend in the side flange 1188 is convex outward. Each of these bends forms a corresponding recess 1230 that faces outward. The recess 1230 of the side flange 1188 is positioned to receive the peak 1214 of the strip 1118. Accordingly, the strip 1118 is limited from moving forward by the walls of the recess 1230, and the strip 1118 is limited from moving rearward by contact with the side flange 1164. Vertical movement of the strip 1118 is limited by friction, contact with the bottom flange 1162, and contact with the top flange 1166.

Additionally, the corresponding curvatures of the components in the door 1114 force the various components of the door 1114 to be in contact along the entire perimeter of the door 1114. This creates a seal, sealing the inner volume of the door 1114 from the surrounding atmosphere. This obstructs (e.g., prevents) moisture and other contaminants from entering the door 1114.

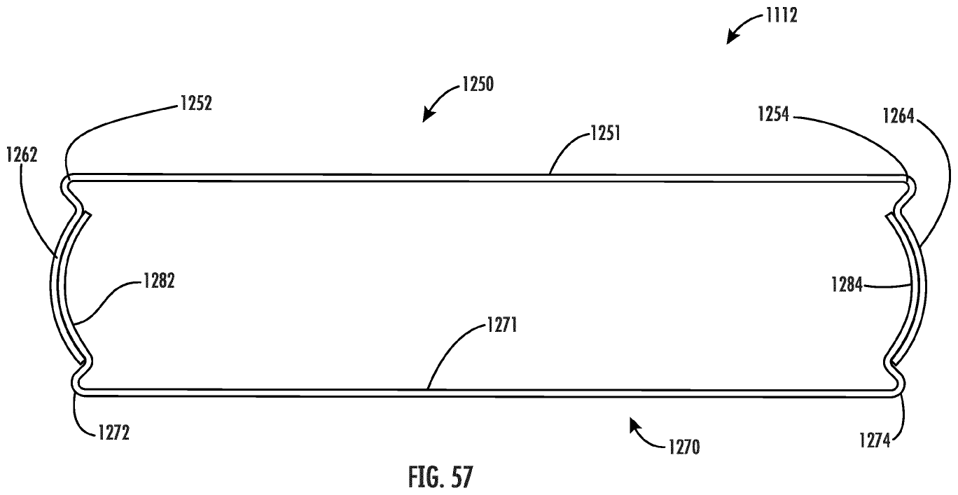

In some embodiments, the pilaster 1110 and/or the pilaster 1112 of the partition system 1100 have a similar construction to the door 1114. Referring to FIG. 57, the construction of the pilaster 1112 is shown according to an exemplary embodiment. In this embodiment, the pilaster 1112 includes a pair of interlocking panels, bodies, or assemblies, shown as panel 1250 and 1270. The panel 1250 and the panel 1270 may have a similar flanged construction (e.g., utilizing interlocking curved flanges) to the panel 1150 and the panel 1170 of the door 1114. As shown, the panel 1250 includes a main body 1251 having a side edge 1252 and a side edge 1254 positioned opposite one another. A side flange 1262 extends along the side edge 1252, and a side flange 1264 extends along the side edge 1254. The panel 1270 includes a main body 1271 having a side edge 1272 and a side edge 1274 positioned opposite one another. A side flange 1282 extends along the side edge 1272, and a side flange 1284 extends along the side edge 1274. The side flange 1282 and the side flange 1284 engage the side flange 1262 and the side flange 1264, respectively, to couple the panel 1250 to the panel 1270.

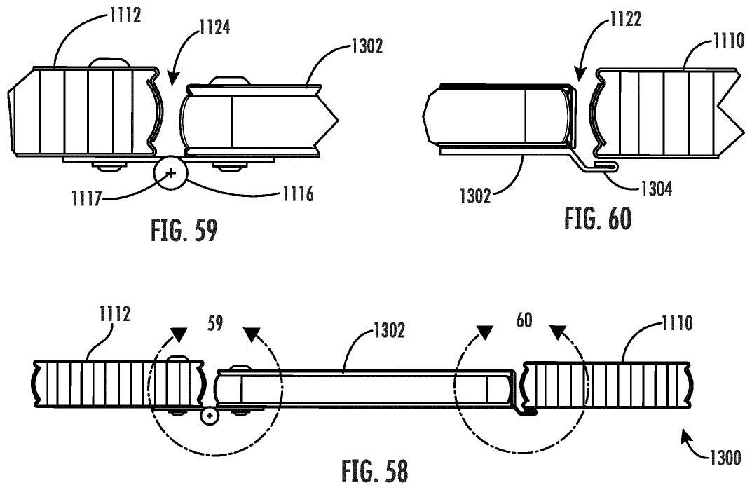

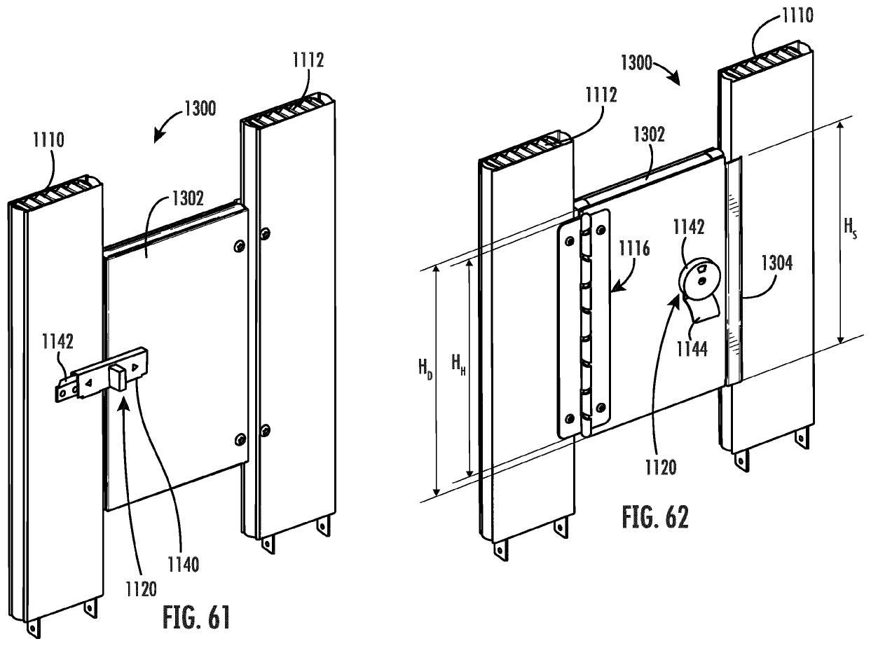

Referring to FIGS. 58-69, a partition system 1300 is shown according to another exemplary embodiment. The partition system 1300 illustrates a modification to the partition system 1100. The partition system 1300 may be substantially similar to the partition system 1100 unless otherwise specified.

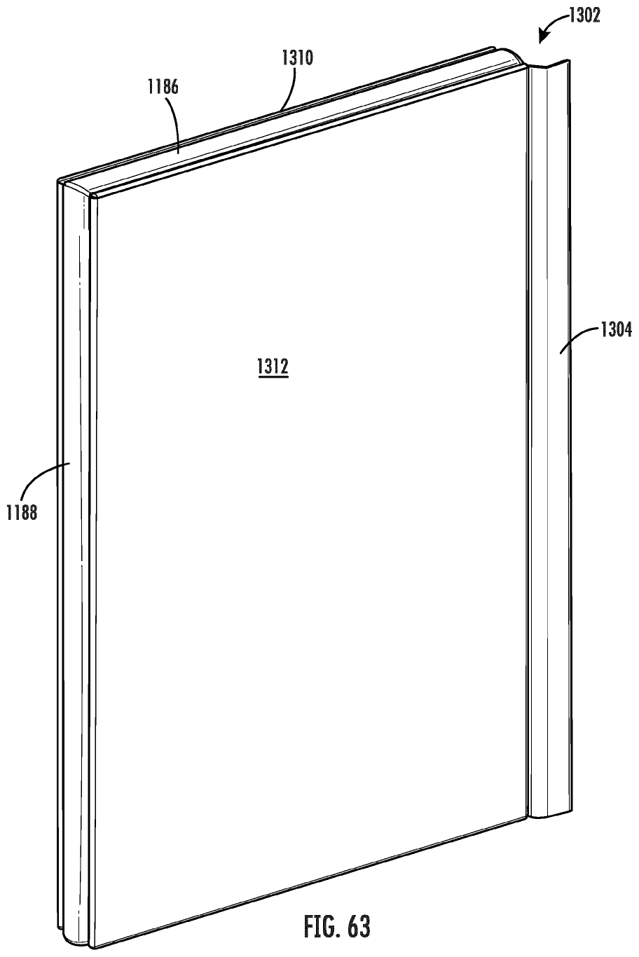

Referring to FIGS. 63-68 and relative to the first embodiment, the door 1114 is replaced with a door 1302 including a no-sight strip, protrusion, sight blocker, sight obscurer, and/or privacy screen, which is shown as strip 1304. The hinge 1116 couples the door 1302 to the pilaster 1112 and extends across the hinge-side gap 1124 between the door 1302 and the pilaster 1112. On a transverse side of the door (i.e., the side that moves away and to the pilaster as the door is opened and closed), the strip 1304 extends across the lock-side gap 1122 between the pilaster 1110 and the door 1302. The hinge 1116 and the strip 1304 are positioned on an exterior surface of the door 1302 such that the door 1302 opens outwards. In other embodiments, the hinge 1116 and the strip 1304 are positioned on an interior surface of the door 1302 such that the door 1302 opens inwards.

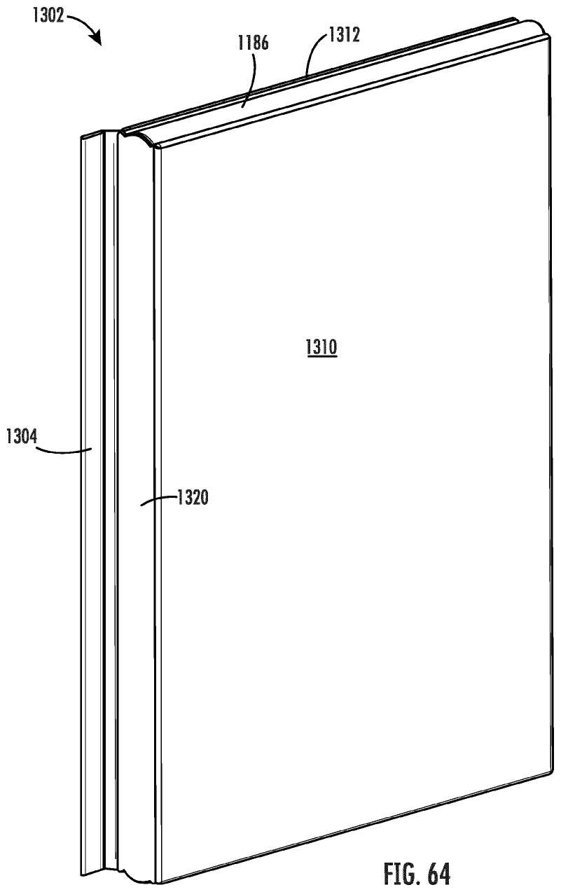

With reference to FIGS. 63 and 64, the door 1302 includes a first panel, body, or assembly, shown as panel 1310, and a second panel, body, or assembly, shown as panel 1312. As shown, the door 1302 opens outward, and the hinge 1116 is positioned on the left side of the door 1302 as viewed from outside the stall. In other embodiments, the door 1302 opens inwards, and/or the hinge 1116 is positioned on the right side of the door 1302 as viewed from outside the stall. As shown, the panel 1310 is an interior panel (i.e., faces toward the stall), and the panel 1312 is an exterior panel (i.e., faces away from the stall). In other embodiments where the door 1302 opens inward, the panel 1310 is an exterior panel, and the panel 1312 is an interior panel. The panel 1312 and the strip 1304 are formed as a single continuous piece. Accordingly, the panel 1312 and the strip 1304 may have a unitary construction. In other embodiments, the panel 1312 and the strip 1304 are formed from multiple separate pieces coupled to one another. The panel 1310 and the panel 1312 are fixedly coupled to one another. By way of example, the panel 1310 and the panel 1312 may be coupled to one another using welding (e.g., tack welding, spot welding, etc.), adhesive (e.g., epoxy, etc.), a press fit (e.g., having a wedge shaped component that is forced between two other components, etc.), interlocking components, fasteners, or other types of coupling. In some embodiments, a filler or strengthening material extends between the panel 1310 and the panel 1312 to strengthen and/or insulate the door 1302.

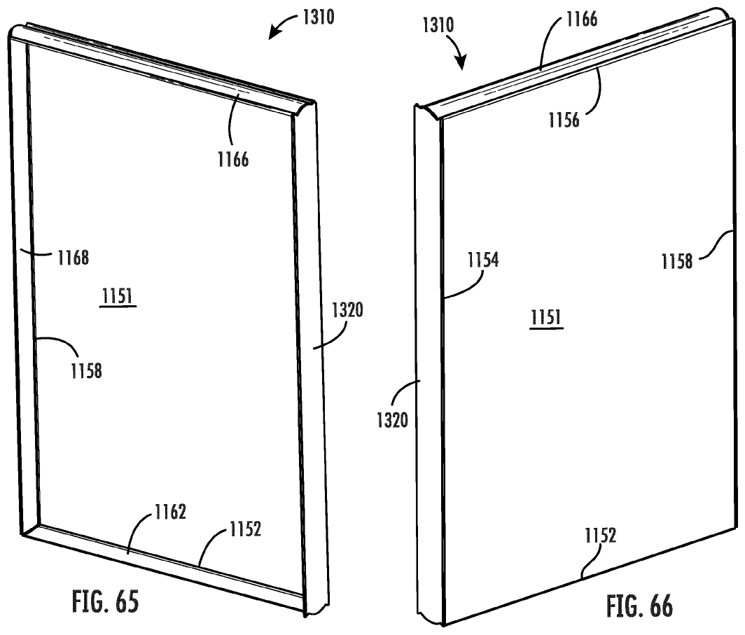

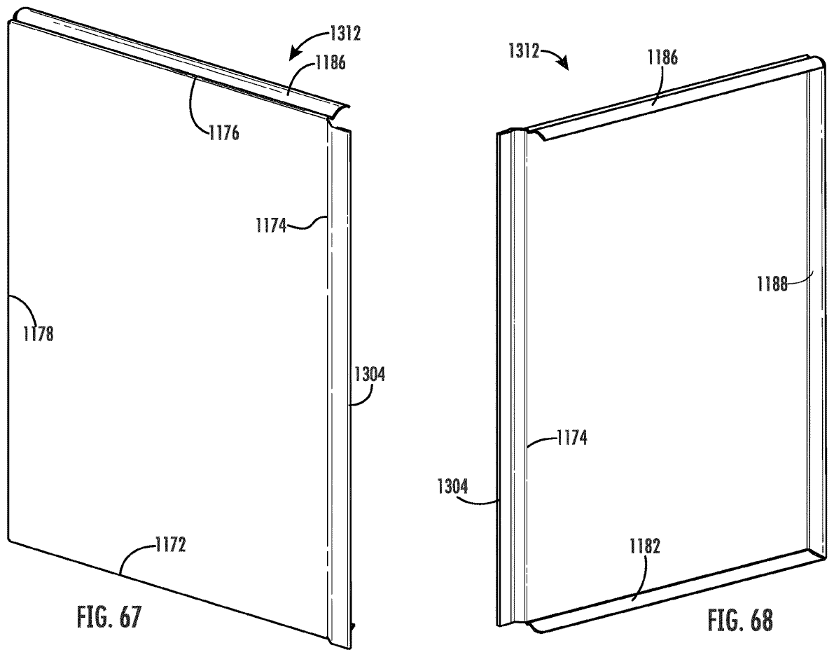

Referring to FIGS. 65 and 66, the panel 1310 is shown according to an exemplary embodiment. The panel 1310 may be substantially similar to the panel 1150 except as otherwise specified. The side flange 1164 is omitted from the panel 1310. Instead, the panel 1310 includes a side flange 1320 extending along the side edge 1154 of the main body 1151. As shown, the side flange 1320 is substantially flat and extends substantially perpendicular to the main body 1151. In other embodiments, the flange 1320 is otherwise shaped. By way of example, the flange 1320 may be flat, curved, trapezoidal, chamfered, or otherwise shaped. The flange 1320 may be tapered or curved along its length. The flange 1320 may be formed from multiple separate sections.

Referring to FIGS. 67 and 68, the panel 1312 is shown according to an exemplary embodiment. The panel 1312 may be substantially similar to the panel 1170 except as otherwise specified. The side flange 1184 is omitted from the panel 1312. Instead, the panel 1312 includes the strip 1304 in place of the side flange 1184. Specifically, the strip 1304 extends along the side edge 1174 of the main body 1171. The strip 1304 and the main body 1171 are formed as a single continuous piece.

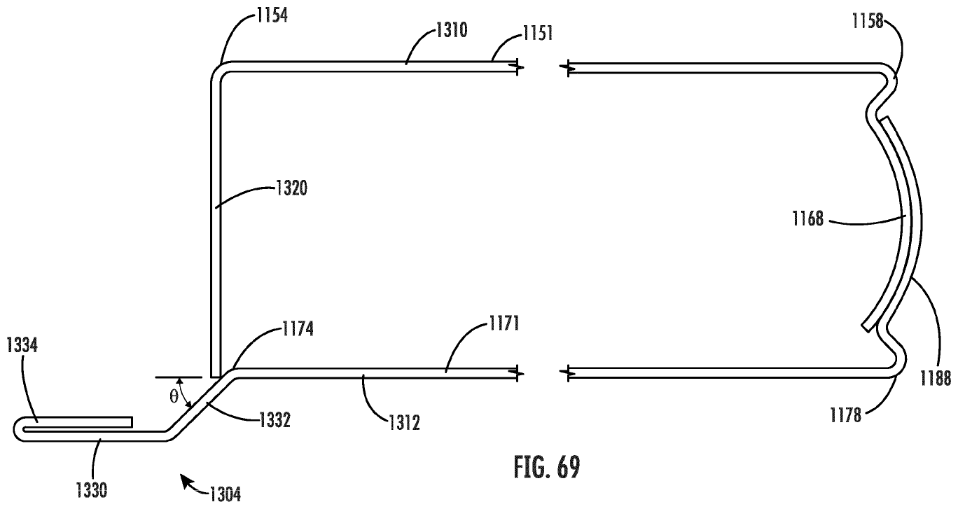

Referring to FIG. 69, the strip 1304 includes a first portion (e.g., an obstructing portion, an obscuring portion, a flat portion, etc.), shown as obscuring portion 1330, a second portion (e.g., an angled portion, an interface portion, a connecting portion, etc.), shown as connecting portion 1332, and a third portion (e.g., a bent portion, a reinforcement portion, etc.), shown as reinforcement portion 1334. The obscuring portion 1330 extends substantially parallel to the main body 1171. The connecting portion 1332 extends between and is coupled to the obscuring portion 1330 and the main body 1171. The connecting portion 1332 is flat and extends at an angle Θ (e.g., 10°, 20°, 30°, 45°, 60°, etc.) relative to the main body 1171 such that the obscuring portion 1330 is offset forward of the main body 1171. As shown, the angle O is approximately 45°. The reinforcement portion 1334 is coupled to an end of the obscuring portion 1330 opposite the connecting portion 1332. An approximately 180 degree bend extends between the obscuring portion 1330 and the reinforcement portion 1334 such that the reinforcement portion 1334 extends along a rear face of the obscuring portion 1330 and substantially parallel to the obscuring portion 1330. This configuration of a bent over or folded over portion relative to another portion may also be referred to as a hem when the door panels are embodied as metal (e.g., aluminum). While most embodiments reflect a closed or crushed hem, other hem configurations are possible, such as a teardrop hem, an open hem, a rolled hem, etc. These types of hem, or others, may be used to create one or more no-sight features described herein. The reinforcement portion 1334 increases the thickness of the strip 1304, thereby increasing the strength of the strip 1304 (e.g., resisting bending of the strip 1304 when the door 1302 is closed). In some embodiments, a sealing portion or dampener similar to the seal 1208 is coupled to the reinforcement portion 1334 such that the dampener engages the pilaster 1110 when the door 1302 is in the closed position. In other embodiments, the strip 1304 is otherwise shaped. By way of example, the obscuring portion 1330, the connecting portion 1332, and/or the reinforcement portion 1334 may be flat, curved, trapezoidal, chamfered, or otherwise shaped. The strip 1304 may be tapered or curved along its length. The strip 1304 may be formed from multiple separate sections.

The flanges of the panel 1310 engage the flanges of the panel 1312 to couple the panel 1310 to the panel 1312. Similar to the arrangement of the door 1114 shown in FIG. 57, the bottom flange 1162 engages the bottom flange 1182, and the top flange 1166 engages the top flange 1186. However, the bottom flange 1182 and the top flange 1186 are spaced farther apart than the bottom flange 1162 and the top flange 1166, such that the bottom flange 1162 and the top flange 1166 extend between the bottom flange 1182 and the top flange 1186. In other embodiments, this arrangement is reversed, and the bottom flange 1182 and the top flange 1186 extend between the bottom flange 1162 and the top flange 1166. As shown in FIG. 69, the side flange 1168 and the side flange 1188 engage one another. As shown, the side flange 1188 is positioned outward of the side flange 1168 such that the side flange 1168 engages an inner surface of the side flange 1188. In other embodiments, the side flange 1168 is positioned outward of the side flange 1188. The side flange 1320 extends toward the panel 1312 and engages the connecting portion 1332 of the strip 1304.

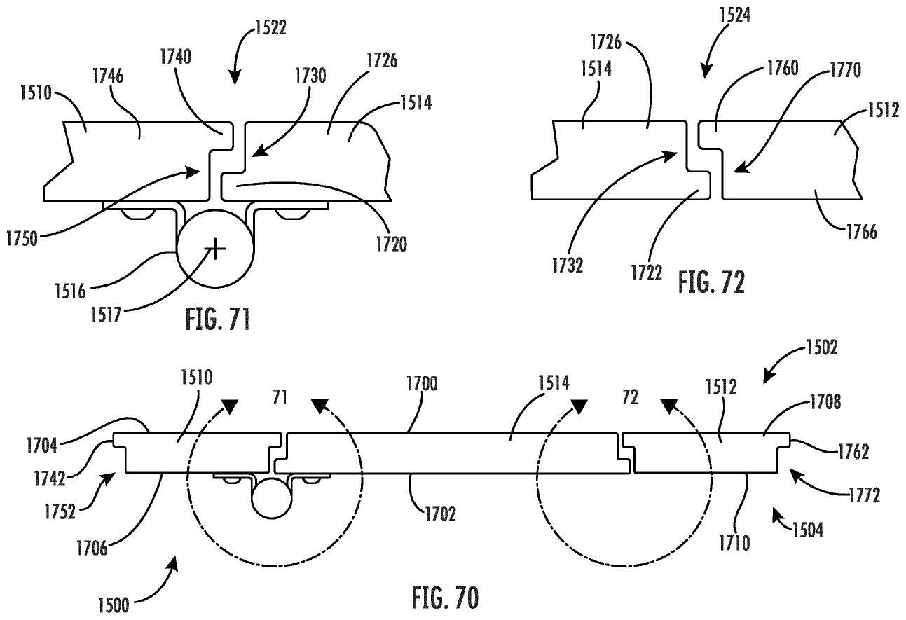

Referring to FIGS. 70-74, another partition system 1500 is shown according to an exemplary embodiment. The partition system 1500 is an example of the partition system 30. The partition system 1500 has a first side or front side 1502 and a second side or rear side 1504. In the embodiment shown, the front side 1502 faces outward, away from the stall 12, and the rear side 1504 faces inward, toward the stall 12. In other embodiments, the front side 1502 faces inward, and the rear side 1504 faces outward. The partition system 1500 includes a pair of pilasters (e.g., faces, stiles, dividers, panels, wall members, etc.), shown as pilaster 1510 and pilaster 1512. A door subassembly, shown as door 1514, is pivotally coupled to the pilaster 1510 by pair of hinge assemblies, shown as hinges 1516, such that the door 1514 rotates about an axis 1517 that extends substantially vertically through the center of the hinges 1516. As shown, the door 1514 opens inward, and the hinges 1516 are positioned on a left side of the door 1514 as viewed from within the stall. In other embodiments, the door 1514 opens outwards, and/or the hinges 1516 are positioned on the right side of the door 1514 as viewed from within the stall. A lock assembly 1120 selectively couples the door 1514 to the pilaster 1512 to selectively prevent movement of the door 1514 out of the closed position. The dimensions of the partition system 1100 shown in FIGS. 70-74 are exemplary only and are not intended to be limiting. In other embodiments, the partition system 1500 is otherwise dimensioned. By way of example, the door 1514 may have a different height and/or width depending upon the desired size of the stall.

The hinges 1516 may be substantially similar to the hinge 1116 except as otherwise specified. Each hinge 1516 includes a first body, shown as hinge plate 1530, pivotally coupled to a second body, shown as hinge plate 1532, by a pin 1534. The hinge plate 1530 is coupled (e.g., fastened) to the pilaster 1510. The hinge plate 1532 is coupled (e.g., fastened) to the door 1514. In the embodiment shown, the partition system 1500 includes two hinges 1516 separated vertically from one another. The hinge 1516 is coupled to the surface of the door 1514 and the pilaster 1510 such that the axis 1517 is offset rearward from the rear surfaces of the door 1514 and the pilaster 1510.

Referring to FIGS. 70-72, a first space or gap, shown as hinge-side gap 1522, extends and is defined between the door 1514 and the pilaster 1510 when the door 1514 is in the closed position. Accordingly, the hinge-side gap 1522 extends along a side of the door 1514 closest to the hinges 1516 (i.e., opposite the lock assembly 1120). A second space or gap, shown as lock-side gap 1524, extends and is defined between the door 1514 and the pilaster 1512 when the door 1514 is in the closed position. Accordingly, the lock-side gap 1524 extends along a side of the door 1514 closest to the lock assembly 1120 (i.e., opposite the hinges 1516). The door 1514 has a first face or surface (e.g., a flat surface), shown as front surface 1700, and a second face or surface (e.g., a flat surface), shown as rear surface 1702. The pilaster 1510 has a first face or surface (e.g., a flat surface), shown as front surface 1704, and a second face or surface (e.g., a flat surface), shown as rear surface 1706. The pilaster 1512 has a first face or surface (e.g., a flat surface), shown as front surface 1708, and a second face or surface (e.g., a flat surface), shown as rear surface 1710.

In order to eliminate a potential line of sight through either the hinge-side gap 1522 or the lock-side gap 1524, the door 1514 and the pilasters 1510, 1512 each include corresponding lips that overlap one another. The door 1514 includes a pair of door lips, protrusions, strips, or shoulders, shown as lip 1720 and lip 1722. The lips 1720 and 1722 extend laterally outward from opposing sides of a main portion, shown as main body 1726, of the door 1514. Specifically, the lip 1720 extends toward the pilaster 1510, and the lip 1722 extends toward the pilaster 1512. A first cutout or recess, shown as recess 1730, is defined between the main body 1726 and the lip 1720. The recess 1730 extends rearward from the front surface 1700, along the main body 1726, to the lip 1720. A second cutout or recess, shown as recess 1732, is defined between the main body 1726 and the lip 1722. The recess 1732 extends rearward from the front surface 1700, along the main body 1726, to the lip 1722. The main body 1726 defines the front surface 1700. Together, the lip 1720, the lip 1722, and the main body 1726 define the rear surface 1702. Accordingly, a width of the rear surface 1702 is greater than a width of the front surface 1700 (i.e., a width of the door 1514 measured at the rear surface 1702 is greater than a width of the door 1514 measured at the front surface 1700).

The pilaster 1510 includes a pair of pilaster lips, protrusions, strips, or shoulders, shown as lip 1740 and lip 1742. The lips 1740 and 1742 extend laterally outward from opposing sides of a main portion, shown as main body 1746, of the pilaster 1510. Specifically, the lip 1740 extends toward the door 1514, and the lip 1742 extends away from the door 1514. A first cutout or recess, shown as recess 1750, is defined between the main body 1756 and the lip 1740. The recess 1750 extends forward from the rear surface 1706, along the main body 1746, to the lip 1740. A second cutout or recess, shown as recess 1752, is defined between the main body 1746 and the lip 1742. The recess 1752 extends forward from the rear surface 1706, along the main body 1746, to the lip 1742. The main body 1746 defines the rear surface 1706. Together, the lip 1740, the lip 1742, and the main body 1746 define the front surface 1704. Accordingly, a width of the front surface 1704 is greater than a width of the rear surface 1706 (i.e., a width of the pilaster 1510 measured at the rear surface 1706 is greater than a width of the pilaster 1510 measured at the front surface 1704).

The pilaster 1512 includes a pair of pilaster lips, protrusions, strips, or shoulders, shown as lip 1760 and lip 1762. The lips 1760 and 1762 extend laterally outward from opposing sides of a main portion, shown as main body 1766, of the pilaster 1512. Specifically, the lip 1760 extends toward the door 1514, and the lip 1762 extends away from the door 1514. A first cutout or recess, shown as recess 1770, is defined between the main body 1766 and the lip 1760. The recess 1770 extends forward from the rear surface 1706, along the main body 1766, to the lip 1760. A second cutout or recess, shown as recess 1772, is defined between the main body 1766 and the lip 1762. The recess 1772 extends forward from the rear surface 1706, along the main body 1766, to the lip 1762. The main body 1766 defines the rear surface 1706. Together, the lip 1760, the lip 1762, and the main body 1766 define the front surface 1704. Accordingly, a width of the front surface 1704 is greater than a width of the rear surface 1706 (i.e., a width of the pilaster 1512 measured at the rear surface 1706 is greater than a width of the pilaster 1512 measured at the front surface 1704).

Referring still to FIGS. 70-72, each lip is received in the recess of an adjacent panel. The lip 1720 of the door 1514 is received in the recess 1750 of the pilaster 1510. The lip 1740 of the pilaster 1510 is received in the recess 1730 of the door 1514. Accordingly, the lip 1740 and the lip 1720 overlap one another, impeding (e.g., reducing, eliminating) a potential line of sight through the hinge-side gap 1522. The lip 1722 of the door 1514 is received in the recess 1770 of the pilaster 1512. The lip 1760 is received in the recess 1732 of the door 1514. Accordingly, the lip 1722 and the lip 1760 overlap one another, impeding (e.g., reducing, eliminating) a potential line of sight through the lock-side gap 1524. The lip 1742 and/or the lip 1762 may have a similar arrangement with doors of other stalls, such that each pilaster may provide a no-sight arrangement with two adjacent doors.

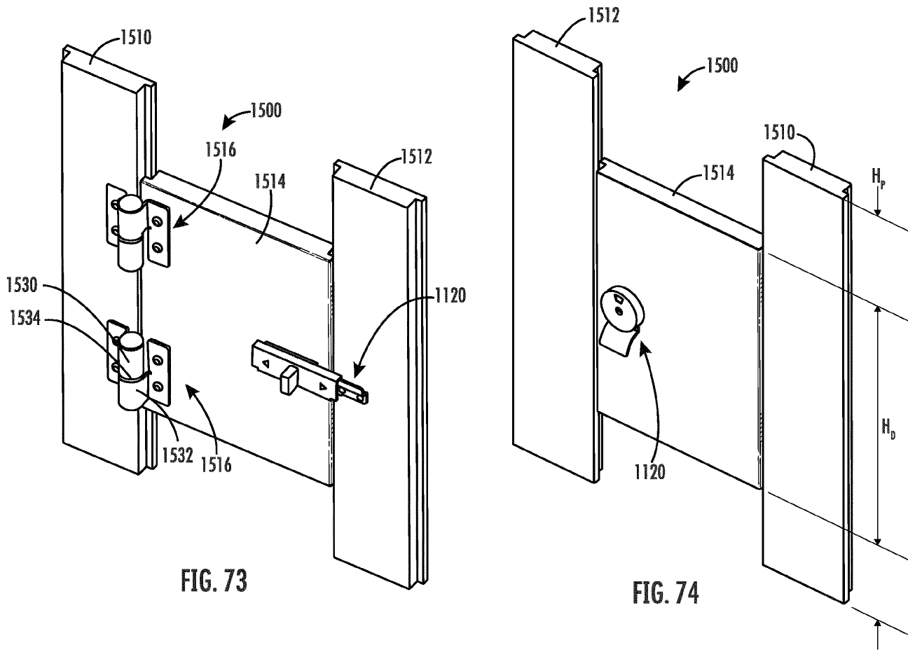

Referring to FIGS. 73 and 74, the door 1114 has a height H_{D} measured vertically, and the lips 1720 and 1722 extend along the entire height H_{D}. The pilasters 1510 and 1512 each have a height Hp measured vertically, and the lips 1740, 1742, 1760, and 1762 extend along or substantially along the entire height of the corresponding pilaster. As shown, the height H_{D} of the door is less than the height HP of the pilasters 1510 and 1512. Accordingly, the lips cover the entirety of the hinge-side gap 1522 and the lock-side gap 1524. In other embodiments, the pilasters 1510 and 1512 are equal in height to the door 1514, and the lips cover the entirety of the hinge-side gap 1522 and the lock-side gap 1524. In yet other embodiments, the lips extend along only a portion of the door 1514, such that only a portion of each gap is covered. By way of example, the lips may cover at least 50%, 75%, 80%, 90%, 95%, or 100% of the hinge-side gap 1522 and the lock-side gap 1524. In this regard, the height or length of the lips on the pilasters 1510, 1512 is highly variable. In some embodiments, the height or length of the lips may match or substantially match the height or length of the door such that the lips do not extend the entire length or height of the pilasters. For example, this configuration may be implemented with plastic constructed pilasters due to the relative ease in manufacturing this less-than-total height lip on the pilaster compared to a metal-construction pilaster.

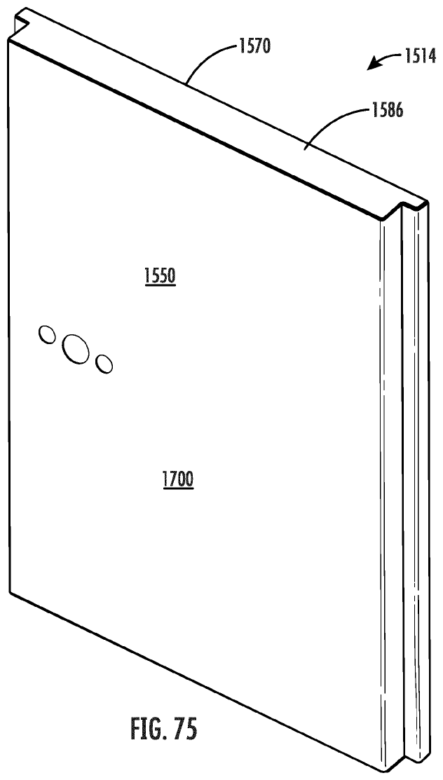

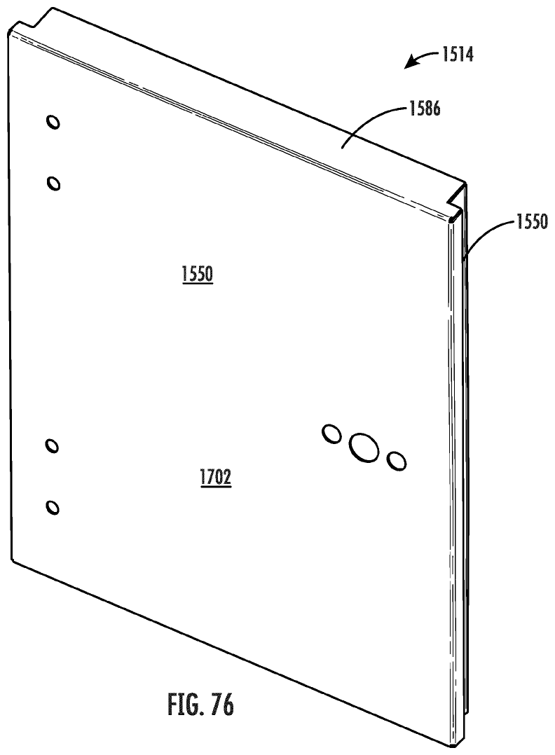

Referring to FIGS. 75 and 76, the door 1114 includes a first panel, body, or assembly, shown as panel 1550, and a second panel, body, or assembly, shown as panel 1570. As shown, the panel 1550 defines the front surface 1700, and the panel 1570 defines the rear surface 1702. The panel 1550 and the panel 1570 are fixedly coupled (e.g., welded, adhered, fastened, etc.) to one another. By way of example, the panel 1550 and the panel 1570 may be coupled to one another using welding (e.g., tack welding, spot welding, etc.), adhesive (e.g., epoxy, etc.), a press fit (e.g., having a wedge shaped component that is forced between two other components, etc.), interlocking components, fasteners, or other types of coupling.

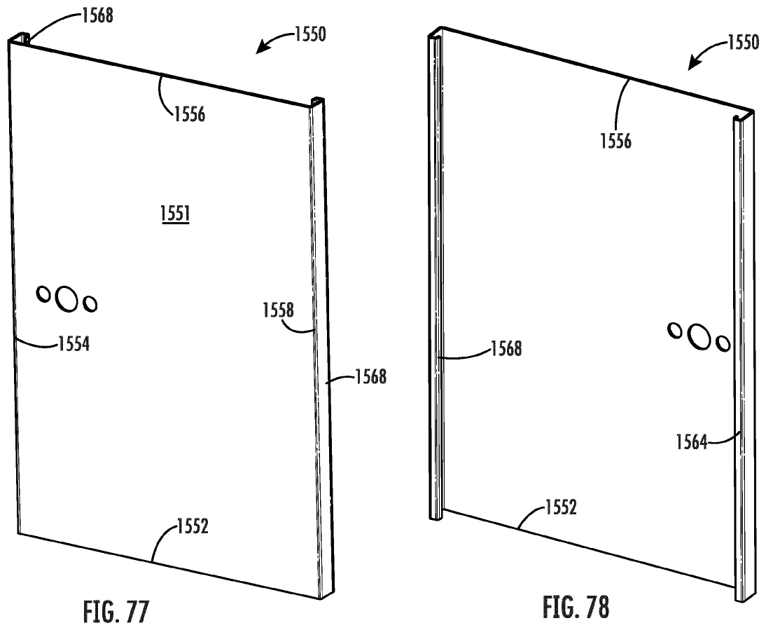

Referring to FIGS. 77 and 78, the panel 1550 is shown according to an exemplary embodiment. The panel 1550 includes a flat, rectangular body or panel, shown as main body 1551. The main body 1551 has a series of edges or contours, shown as bottom edge 1552, side edge 1554, top edge 1556, and side edge 1558. The bottom edge 1552 is positioned opposite the top edge 1556, and the side edge 1554 is positioned opposite the side edge 1558. As shown, each of the edges are substantially straight. A series of protrusions or flanges extend away from the main body 1551 and along a corresponding edge. Specifically, a side flange 1564 extends along the side edge 1554, and a side flange 1568 extends along the side edge 1558. The main body 1551, the side flange 1564, and the side flange 1568 are formed as a single, continuous piece. By way of example, the side flange 1564, the side flange 1568, and the main body 1551 may be formed from a single piece of bent sheet metal. Accordingly, the panel 1550 may have a unitary construction. In other embodiments, the panel 1550 is formed from multiple separate pieces coupled to one another.

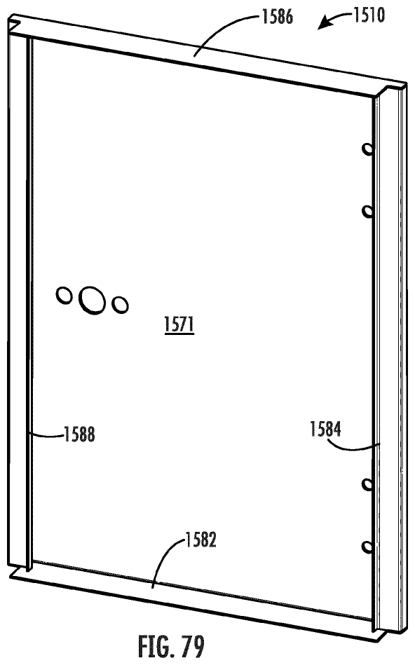

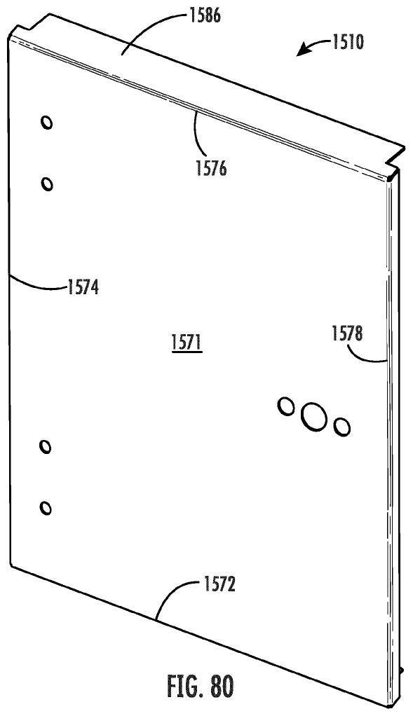

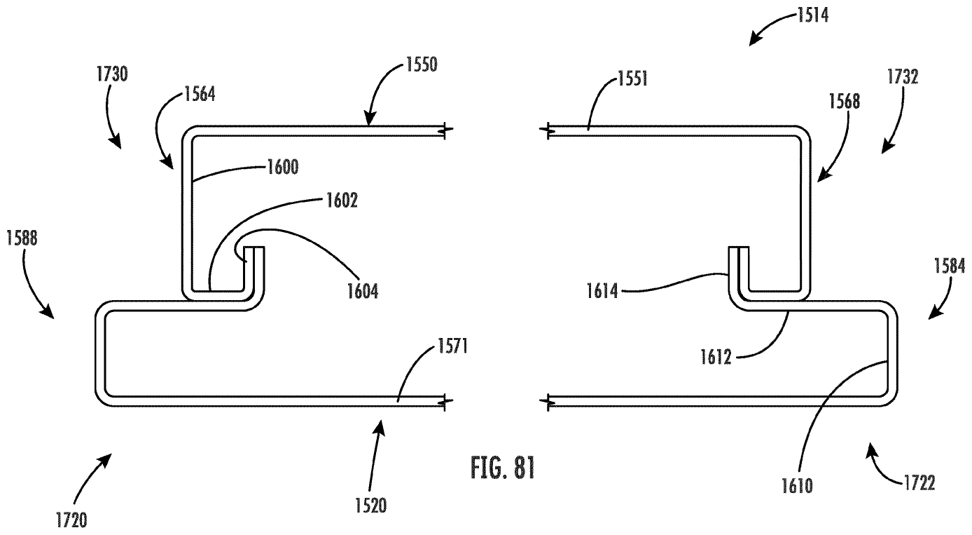

Referring to FIGS. 79 and 80, the panel 1570 is shown according to an exemplary embodiment. The panel 1570 includes a flat, rectangular body or panel, shown as main body 1571. The main body 1571 has a series of edges or contours, shown as bottom edge 1572, side edge 1574, top edge 1576, and side edge 1578. The bottom edge 1572 is positioned opposite the top edge 1576, and the side edge 1574 is positioned opposite the side edge 1578. As shown, each of the edges are substantially straight. A series of protrusions or flanges extend away from the main body 1571 and along a corresponding edge. Specifically, a bottom flange 1582 extends along the bottom edge 1572, a side flange 1584 extends along the side edge 1574, a top flange 1586 extends along the top edge 1576, and a side flange 1588 extends along the side edge 1578. The main body 1571, the bottom flange 1582, the side flange 1584, the top flange 1586, and the side flange 1588 are formed as a single, continuous piece. By way of example, the bottom flange 1582, the side flange 1584, the top flange 1586, and the side flange 1588 and the main body 1571 may be formed from a single piece of bent sheet metal. Accordingly, the panel 1570 may have a unitary construction. In other embodiments, the panel 1570 is formed from multiple separate pieces coupled to one another.

Referring to FIG. 81, the side flange 1564 and the side flange 1568 each include a series of connected sections (e.g., connecting portions, obscuring portions, flat portion, panels, etc.), shown as base portion 1600, middle portion 1602, and tip portion 1604. The side flange 1564 and the side flange 1568 may be symmetrical. A proximal edge of the base portion 1600 is directly coupled to the main body 1551. A proximal edge of the middle portion 1602 is coupled to a distal edge of the base portion 1600. A proximal edge of the tip portion 1604 is coupled to a distal edge of the middle portion 1602. As shown, the base portion 1600, the middle portion 1602, and the tip portion 1604 are each substantially flat and connected to one another along their adjacent vertical edges by bends. The middle portion 1602 is substantially parallel to the main body 1551 and extends inward (e.g., toward a centerline of the door 1514). The base portion 1600 and the tip portion 1604 are substantially perpendicular to the main body 1551. The tip portion 1604 extends toward the main body 1551.

Referring again to FIG. 81, the side flange 1584 and the side flange 1588 each include a series of connected sections (e.g., connecting portions, obscuring portions, flat portion, panels, etc.), shown as base portion 1610, middle portion 1612, and tip portion 1614. The side flange 1584 and the side flange 1588 may be symmetrical. A proximal edge of the base portion 1610 is directly coupled to the main body 1571. A proximal edge of the middle portion 1612 is coupled to a distal edge of the base portion 1610. A proximal edge of the tip portion 1614 is coupled to a distal edge of the middle portion 1612. As shown, the base portion 1610, the middle portion 1612, and the tip portion 1614 are each substantially flat and connected to one another along their adjacent vertical edges by bends. The middle portion 1612 is substantially parallel to the main body 1571 and extends inward (e.g., toward a centerline of the door 1514). The base portion 1610 and the tip portion 1614 are substantially perpendicular to the main body 1571. The tip portion 1614 extends away from the main body 1571.

The side flange 1564 engages the side flange 1588 and the side flange 1568 engages the side flange 1584 to couple the panel 1550 to the panel 1570. Specifically, the middle portion 1602 engages the corresponding middle portion 1612, and the tip portion 1604 engages the corresponding tip portion 1614. These engaged surfaces may be coupled to one another (e.g., by welding, fasteners, adhesive, etc.). The tip portions 1614 are positioned between the tip portions 1604.

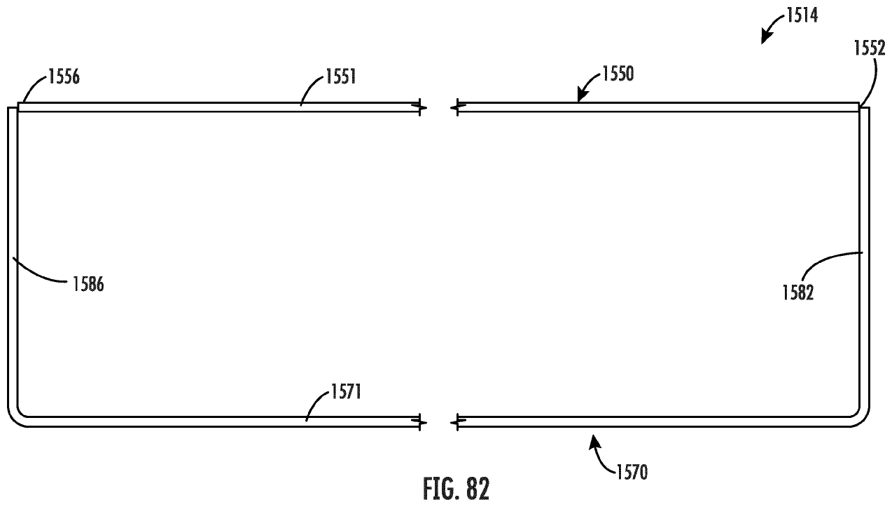

Referring to FIG. 82, the bottom flange 1582 and the top flange 1586 are each flat and extend substantially perpendicular to the main body 1571. The bottom flange 1582 extends above the bottom edge 1552. The top flange 1586 extends below the top flange 1586.

As shown, the lips and the main bodies of the pilaster 1510, the pilaster 1512, and the door 1514 each have a substantially rectangular cross section that is substantially constant throughout the height of the partition system 1500. In other embodiments, the pilaster 1510, the pilaster 1512, and/or the door 1514 are otherwise shaped. By way of example, the cross section of the main body and/or the lips may be rectangular, square, semicircular, elliptical, chamfered, triangular, trapezoidal, or otherwise shaped. By way of another example, the pilaster 1510, the pilaster 1512, and/or the door 1514 may have cross sections that vary (e.g., taper) over their height.

### Alternative Pilaster Configuration

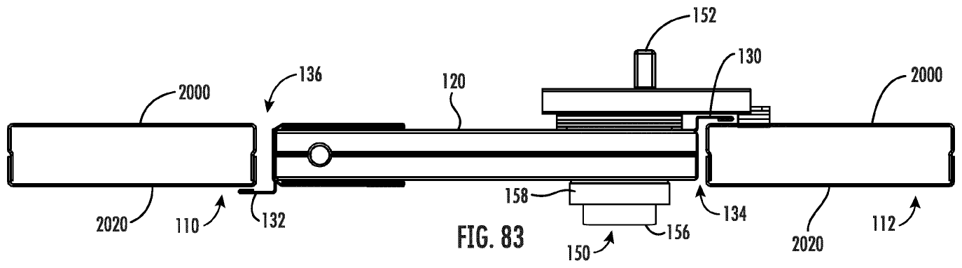

Referring to FIGS. 83-85, the partition system 100 is shown with the pilaster 110 and the pilaster 112 having an alternative construction, according to an exemplary embodiment. In some embodiments, the pilaster 112 has a similar construction to the pilaster 110. In this embodiment, the pilaster 110 includes a pair of interlocking panels, bodies, or assemblies, shown as panel 2000 and 2020. The panel 2000 and the panel 2020 may have a similar flanged construction (e.g., utilizing interlocking flanges) to other embodiments described herein (e.g., top flange 186 of the panel 170 and the top flange 206 of the panel 190 of the door 330 shown in FIG. 16).

As shown, the panel 2000 includes a main body 2002 defining a face (e.g., a front face, a rear face, etc.) of the pilaster 110. The main body 2002 has a pair of vertical side edges positioned opposite one another. A vertical flange, shown as side flange 2004, extends along each of these vertical side edges, such that the side flanges 2004 also extend vertically. Each side flange 2004 includes an outer portion or connecting portion, shown as exposed portion 2006, and an inner portion, offset portion, covered portion, or jogged portion, shown as inset portion 2008. In the example shown, the exposed portion 2006 and the inset portion 2008 are formed as a single, continuous piece (e.g., a bent piece of sheet metal) with the main body 2002. In other embodiments, the exposed portion 2006 and inset portion 2008 may be formed from two or more pieces or elements. The exposed portion 2006 and the inset portion 2008 are both substantially perpendicular to the main body 2002. The exposed portion 2006 extends between the main body 2002 and the inset portion 2008, coupling the inset portion 2008 to the main body 2002. The inset portion 2008 is offset inward from the exposed portion 2006 by the thickness of the material used to form the panel 2020. In other embodiments, a filler or addition material may be used to increase the offset, if desired.

As shown, the panel 2020 includes a main body 2022 defining a face (e.g., a front face, a rear face, etc.) of the pilaster 110. The main body 2022 has a pair of vertical side edges positioned opposite one another. A vertical flange, shown as side flange 2024, extends along each of these vertical side edges, such that the side flanges 2024 also extend vertically. The side flanges 2024 each engage one of the side flanges 2004 to couple the panel 2000 to the panel 2020.

When assembled, the inset portion 2008 of the side flange 2004 extends along an inner surface of the corresponding side flange 2024. As the inset portions 2008 abut the side flanges 2024, the inset portions 2008 may be fixedly coupled to the side flanges 2024 though welding (e.g., plug welding, laser welding, etc.), adhesive (e.g., epoxy, glue, etc.), fasteners (e.g., rivets, screws, etc.), or another type of coupling. By offsetting the inset portions 2008 relative to the exposed portions 2006, the exposed portions 2006 may be substantially coplanar with the side flanges 2024 while the inset portions 2008 internally overlap the side flanges 2024 to facilitate coupling the panels 2000 and 2020 together.

### Sidewall Configuration

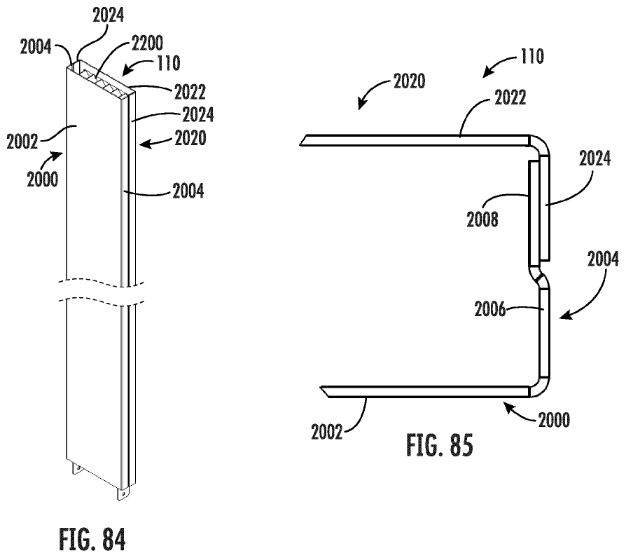

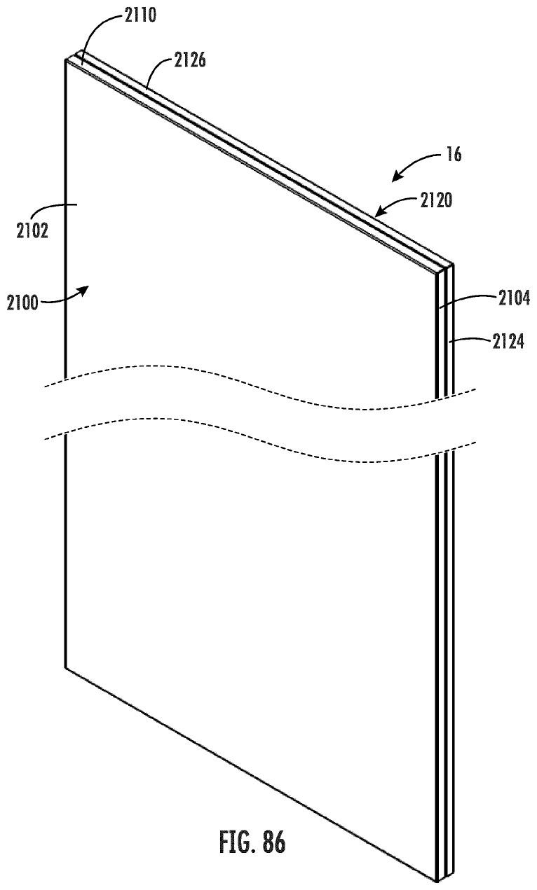

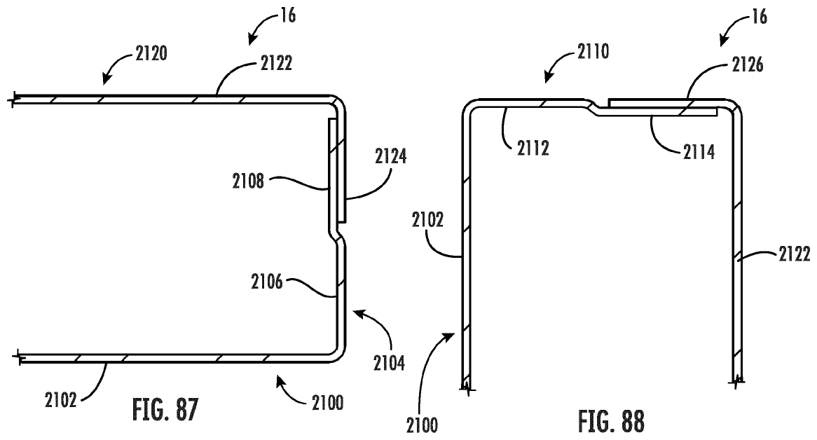

Referring to FIGS. 86-88, a sidewall 16 of the partition system 10 of FIG. 1 is shown according to another exemplary embodiment. In this embodiment, the sidewall 16 includes a pair of interlocking panels, bodies, or assemblies, shown as panel 2100 and 2120. The panel 2100 and the panel 2120 may have a similar flanged construction (e.g., utilizing interlocking flanges) to other embodiments described herein (e.g., top flange 186 of the panel 170 and the top flange 206 of the panel 190 of the door 330 shown in FIG. 16, the pilaster 110 of FIG. 84, etc.).

As shown, the panel 2100 includes a main body 2102 defining a face (e.g., a front face, a rear face, etc.) of the sidewall 16. The main body 2102 has a pair of vertical side edges positioned opposite one another and a pair of horizontal edges (e.g., a top edge and a bottom edge) positioned opposite one another. A vertical flange or side flange, shown as vertical flange 2104, extends along each vertical side edge of the main body 2102, such that the vertical flanges 2104 also extend vertically. Each vertical flange 2104 includes an outer portion or connecting portion, shown as exposed portion 2106, and an inner portion, offset portion, covered portion, or jogged portion, shown as inset portion 2108. In some embodiments, the exposed portion 2106 and the inset portion 2108 may be formed as a single, continuous piece (e.g., a bent piece of sheet metal) with the main body 2102. The exposed portion 2106 and the inset portion 2108 are both substantially perpendicular to the main body 2102. The exposed portion 2106 extends between the main body 2102 and the inset portion 2108, coupling the inset portion 2108 to the main body 2102. The inset portion 2108 is offset inward from the exposed portion 2106 by the thickness of the material used to form the panel 2120.

A horizontal or substantially horizontal flange (horizontal relative to a floor or ground surface), top flange, or bottom flange, shown as horizontal flange 2110, extends along each horizontal side edge of the main body 2102, such that the horizontal flanges 2110 also extend horizontally. Each horizontal flange 2110 includes an outer portion or connecting portion, shown as exposed portion 2112, and an inner portion, offset portion, covered portion, or jogged portion, shown as inset portion 2114. The exposed portion 2112 and the inset portion 2114 are formed as a single, continuous piece (e.g., a bent piece of sheet metal) with the main body 2102. The exposed portion 2112 and the inset portion 2114 are both substantially perpendicular to the main body 2102. The exposed portion 2112 extends between the main body 2102 and the inset portion 2114, coupling the inset portion 2114 to the main body 2102. In the example shown, the inset portion 2114 is offset inward from the exposed portion 2112 by the thickness of the material used to form the panel 2120. In other embodiments, a filler or additional material may be added to increase the offset inward from the exposed portion 2112 (e.g., to add more stiffness and/or rigidity).

As shown, the panel 2120 includes a main body 2122 defining a face (e.g., a front face, a rear face, etc.) of the sidewall 16. The main body 2122 has a pair of vertical side edges positioned opposite one another and a pair of horizontal or substantially horizontal edges relative to a horizontal ground or support surface, shown as a top edge and a bottom edge, positioned opposite one another. A vertical flange, shown as vertical flange 2124, extends along each of the vertical side edges, such that the vertical flanges 2124 also extend vertically. The vertical flanges 2124 each engage one of the vertical flanges 2104 to couple the panel 2000 to the panel 2120. A horizontal or substantially horizontal flange, shown as horizontal flange 2126, extends along each of the horizontal side edges, such that the horizontal flanges 2126 also extend horizontally. The horizontal flanges 2126 each engage one of the horizontal flanges 2110 to couple the panel 2100 to the panel 2120.

When assembled, the inset portion 2108 of each vertical flange 2104 extends along an inner surface of the corresponding vertical flange 2124. Similarly, the inset portion 2114 of each horizontal flange 2110 extends along an inner surface of the corresponding horizontal flange 2126. As the inset portions abut the corresponding flanges, the inset portions may be fixedly coupled to the flanges though welding (e.g., plug welding, laser welding, etc.), adhesive (e.g., epoxy, glue, etc.), fasteners (e.g., rivets, screws, etc.), or another type of fixed coupling. By offsetting the inset portions relative to the exposed portions, the exposed portions may be substantially coplanar with the corresponding vertical flanges 2124 and horizontal flanges 2126 while the inset portions internally overlap the flanges to facilitate coupling the panels 2100 and 2120 together.

### Alternative Strip Design

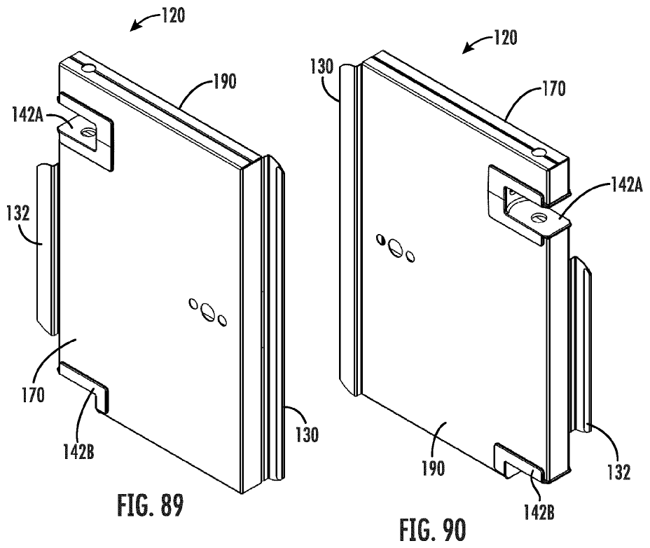

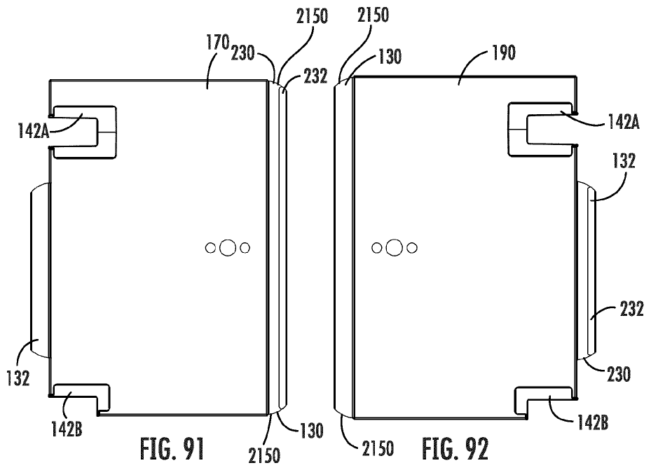

Referring to FIGS. 89-92, the door 120 is shown with an alternative shape of the strips 130 and 132. The door 120 of FIGS. 89-92 may be substantially similar to the door 120 of FIG. 9, except as otherwise specified herein. As shown in FIGS. 89-92, the door 120 includes a strip 130 and a strip 132, each extending substantially vertically relative to a horizontal surface (e.g., a ground or support surface for the door 120). The top and bottom ends of the strip 130 and the strip 132 are each formed with a radius or fillet 2150. This fillet 2150 may prevent objects (e.g., clothing, cleaning equipment, etc.) from catching or snagging on a corner of the door 120 when a user passes by the door 120.

### Cardboard Filler

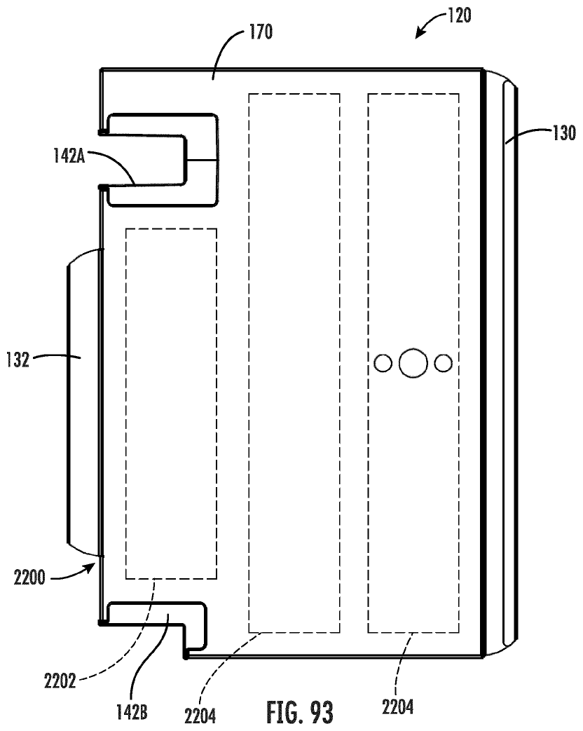

Referring to FIG. 93, the door 120 is shown including a structural infill, void filler, and/or reinforcement, insulator, and/or noise dampener, shown as filler 2200. The filler 2200 occupies a void formed between the panel 170 and the panel 190. The filler 2200 may be formed from cardboard material (e.g., having a honeycomb cross section, etc.) or another filing material. The filler 2200 may be secured directly to at least one interior surface of the main body 171 and the main body 191, such as with an adhesive. The filler 2200 couples the panel 170 to the panel 190, increasing the rigidity of the door 120 and holding the panels 170 together during welding or other coupling operations. The filler 2200 may also reduce the transmission of sound through the door 120 by dissipating or otherwise dampening vibrations. While the filler 2200 is shown in the door 120 in FIG. 93, the filler 2200 may be utilized in any other component of the partition system, such as the pilasters 110 and 112 (e.g., as shown in FIGS. 5 and 6) or the sidewalls 16.

Depending upon the dimensions of the room where the partition system 10 is utilized, the components of the partition system 10 may vary in size. By way of example, the door 120 may be offered in a variety of different heights (i.e., the vertical dimension of the door 120 in FIG. 93) and/or widths (i.e., the lateral dimension of the door 120 in FIG. 93). In other partition systems, filler is provided as a single piece that is custom made to fit the desired dimensions of the door. This process increases the expense and complexity of manufacturing the door, as the manufacturer must provide a different size of filler for each size of door.

To address this common problem, the filler 2200 is configured to facilitate manufacturing a variety of differently-sized doors 120 using a common set of filler components. As shown, the filler 2200 includes several separate pieces having common dimensions. Specifically, as shown, the door 120 includes a filler strip 2202 and a pair of filler strips 2204, each extending substantially vertically within the door 120. The filler strips 2202 and 2204 all have the same width, and the filler strips 2204 have the same height. The height of the filler strip 2202 is less than the height of the filler strips 2204 to facilitate placing the strip 2202 between the hinge body 142A and the hinge body 142B.

When preparing to manufacture a series of doors 120 having different widths, the manufacturer may produce a large quantity of the filler strips 2204. The filler strips 2204 may be added to the door 120 (e.g., from right to left as shown in FIG. 93) until the door 120 can no longer accommodate any additional filler strips 2204. Due to the positions of the hinge body 142A and the hinge body 142B and the size of the filler strips 2204, the filler strips 2204 cannot fit between the hinge bodies 142A and 142B. To accommodate the shortened void between the hinge bodies 142A and 142B, one or more of the filler strips 2204 can be cut to length to form the filler strips 2202, and the filler strips 2202 can be added to the door 120 between the hinge bodies 142A and 142B. If a door 120 of a different width is desired, filler strips 2202 and/or 2204 can be added or omitted as necessary to match the width of the door 120. Accordingly, one size of filler strip can be used to accommodate doors 120 having a variety of different widths, reducing the complexity of the manufacturing process.

The height of the filler strip 2204 may be selected to accommodate doors 120 of differing heights. In some embodiments, the filler strip 2204 is sized to accommodate the door 120 having the largest height offered by the manufacturer. When producing a door 120 with this relatively large height, the filler strips 2204 may be used in their original form. When producing a door 120 with a smaller height, the filler strips 2204 may be cut to length to fit the height of the door 120. In other embodiments, the manufacturer may produce a different sizes of filler strips 2204 for each height of door 120 that is offered.

In some embodiments, the filler strips can be added or removed to accommodate doors of differing heights. By way of example, the filler strips may extend widthwise (e.g., laterally) in the door 120. In such an example, the manufacturer may produce one filler strip corresponding to the width of the door 120, and the amount of the filler strips in the vertical direction may be varied to accommodate doors 120 of varying heights.

In some embodiments, the filler strips can be added or removed to accommodate doors of differing heights and widths. By way of example, the door 120 may include multiple filler strips in the width direction (e.g., multiple columns of filler strips) and multiple filler strips in the height direction (e.g., multiple rows of filler strips). In such an example, the manufacturer may vary the number of rows of filler strips to accommodate doors 120 of differing heights and/or may vary the number of columns of filler strips to accommodate doors 120 of differing widths.

Each of the embodiments disclosed herein may utilize one or more of a variety of different materials. By way of example, any of the partitions described herein, such as the sidewalls (e.g., the sidewalls 16), the pilasters (e.g., the pilaster 22, the pilaster 1110, the pilaster 1510, etc.), and the doors (e.g., the door 20, the door 1114, the door 1514, etc.), may utilize metals and/or metal alloys (e.g., steel, aluminum, copper, brass, etc.), wood (e.g., pine, oak, etc.), plastics (e.g., UHMW, PVC, etc.), composites (e.g., carbon fiber, metal reinforced plastics, etc.), other materials, or a combination thereof. The materials may be solid, formed from bent or coupled sheets, hollow, or otherwise formed.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the cap 292 of the exemplary embodiment shown in at least FIG. 19 may be incorporated in the door 120 of the exemplary embodiment shown in at least FIG. 9. Although only one example of an element from one embodiment that can be incorporated or utilized in another embodiment has been described above, it should be appreciated that other elements of the various embodiments may be incorporated or utilized with any of the other embodiments disclosed herein.

1. A partition system, comprising:
a pilaster; and
a door repositionable relative to the pilaster between an open position and a closed position, the door including:
a first panel including a first body and a strip formed as a first continuous piece, the body defining at least one of a front face or a rear face of the door, and the strip being offset from the first body; and
a second panel coupled to the first panel, the second panel including a second body and a flange formed as a second continuous piece,
wherein a gap extends between the flange and the pilaster when the door is in the closed position, and wherein the strip extends across at least part of the gap when the door is in the closed position.

2. The partition system of claim 1, wherein the flange extends between the first body and the second body, and wherein the flange engages the first panel to couple the first panel to the second panel.

3. The partition system of claim 2, wherein the flange includes a first portion that extends substantially parallel to the second body and a second portion that extends between the second body and the first portion, and wherein the first portion of the flange engages the first body of the first panel.

4. The partition system of claim 1, wherein the pilaster is a first pilaster, the gap is a first gap, and the strip is a first strip, the partition system further comprising a second pilaster positioned to form a second gap between the door and the second pilaster, wherein the second panel further includes a second strip formed as part of the second continuous piece, wherein the second strip extends across the second gap when the door is in the closed position.

5. The partition system of claim 4, wherein the flange is a first flange, wherein the first panel further includes a second flange formed as part of the first continuous piece, and wherein the second flange extends between the first body and the second body and selectively engages the second panel.

6. The partition system of claim 1, wherein the flange is a first flange, wherein the first panel includes a second flange formed as part of the first continuous piece, wherein the first flange engages the second flange to couple the first panel to the second panel.

7. The partition system of claim 6, wherein the second flange includes a first portion extending substantially perpendicular to the first body and a second portion offset from the first portion, and wherein the second portion engages an inner surface of the first flange to couple the first panel to the second panel.

8. The partition system of claim 7, wherein the first flange extends along at least one of a top edge or a bottom edge of the door.

9. The partition system of claim 1, further comprising a hinge pivotally coupling the door to the pilaster.

10. The partition system of claim 1, wherein the pilaster is a first pilaster, further comprising a second pilaster and a hinge pivotally coupling the door to the second pilaster.

11. The partition system of claim 1, wherein the door is rotatable relative to the pilaster about a substantially vertical axis, and wherein the strip extends substantially vertically.

12. The partition system of claim 1, wherein the strip covers at least 75% of the gap as measured along a length of the gap when the door is in the closed position.

13. An assembly for a partition system, the assembly comprising:
a first panel including a first body and a first flange formed as a first continuous piece, the first body defining a first face of the assembly, and the first flange extending substantially perpendicular to the first face; and
a second panel including a second body and a second flange formed as a second continuous piece, the second body defining a second face of the assembly, and the second flange extending substantially perpendicular to the second face;
wherein the first flange includes a connecting portion and an offset portion that is offset from the connecting portion, wherein the connecting portion extends between the first body and the offset portion, and wherein the offset portion engages the second flange to couple the first panel to the second panel; and
wherein the first panel includes a strip that is formed as part of the first continuous piece, wherein the strip is offset from the first body, and wherein the strip is positioned to extend toward the pilaster when the door is in a closed position.

14. The assembly of claim 13, wherein the assembly forms at least part of at least one of a door, a pilaster, or a sidewall of the partition system.

15. The assembly of claim 14, wherein the assembly forms at least part of the door of the partition system, further comprising a hinge coupled to the first panel and the second panel and configured to permit rotation of the door relative to a pilaster of the partition system.

16. (canceled)

17. (canceled)

18. (canceled)

19. A partition system defining a stall, the partition system comprising:
a first pilaster;
a second pilaster; and
a door positioned to form a first gap between the door and the first pilaster and a second gap between the door and the second pilaster, the door including:
a first panel defining an interior face of the door that faces toward the stall, the first panel including a first vertical strip offset from the interior face of the door and extending across the first gap; and
a second panel defining an exterior face of the door that faces away from the stall, the second panel including a second vertical strip offset from the exterior face of the door and extending across the second gap and a flange coupling the second panel to the first panel.

20. The partition system of claim 19, wherein the flange is a first flange, and wherein the first panel further includes a second flange engaging the first flange.

21. The partition system of claim 4, wherein the second strip is offset from the second body.

22. The partition system of claim 1, wherein the strip includes a primary portion and a secondary folded portion folded thereover.

23. The partition system of claim 1, further comprising a sealing portion coupled to the strip.
